(19) United States
(12) Patent Application Publication
(10) Pub. No.: US 2025/0378393 A1
(43) Pub. Date: Dec. 11, 2025

(54) Methods and Systems for Determining an Optimal Ensemble Model Configuration

(71) Applicant: Mastercard International Incorporated, Purchase, NY (US)

(72) Inventors: Pranav Poduval, Noida (IN); Gaurav Oberoi, Meerut (IN); Sanjay Kumar Patnala, Gurgaon (IN); Nitish Kumar, Jamshedpur (IN); Siddhartha Asthana, New Delhi (IN)

(21) Appl. No.: 19/231,466

(22) Filed: Jun. 7, 2025

(30) Foreign Application Priority Data
Jun. 10, 2024 (IN) 202441044778

(51) Int. Cl. G06N 20/20

(52) U.S. Cl. CPC G06N 20/20

(57) ABSTRACT

Methods and systems for determining a recommended ensemble model configuration is disclosed. Method performed by server system includes access a validation dataset and generating one or more ensemble model configurations. Each ensemble model configuration includes a subset of base models. Operations are performed iteratively for each ensemble model configuration till predefined criteria are met. Operations include determining, by the subset of base models, a set of predictions, computing, one or more prediction losses, computing a pairwise diversity loss metric for the subset of base models, and fine-tuning the subset of base models on backpropagating the one or more prediction losses and the pairwise diversity loss metric. Method includes determining the recommended ensemble model configuration based on each ensemble model configuration including the subset of fine-tuned base models.

### TECHNICAL FIELD

The present disclosure relates to artificial intelligence-based processing systems and, more particularly, to electronic methods and complex processing systems for determining an optimal (or recommended) ensemble model configuration for a down-stream task from one or more ensemble model configurations.

### BACKGROUND

In recent times, there has been a widespread adoption of Artificial Intelligence (AI) and/or Machine Learning (ML) models across various real-time applications. Further, remarkable advancements have been made in the field of AI/ML, including the introduction of novel architectures and scaling techniques across various domains such as computer vision, natural language processing, and recommendation systems. However, designing bespoke solutions for individual problems is knowledge-intensive and laborious, presenting a significant barrier to entry. This challenge is further compounded by the “No Free Lunch” theorem, which asserts that no single ML algorithm can consistently outperform others across all applications. This relevance is underscored by the intricate processes of algorithm selection, hyperparameter tuning, and neural architecture search. Moreover, the increasing sophistication of state-of-the-art ML techniques poses a significant challenge for experts attempting to integrate the latest best practices into their models. In response to these challenges, various Automated Machine Learning (AutoML) techniques have been developed. One such technique is called Combined Algorithm Selection and Hyperparameter (CASH) Optimization. The CASH optimization technique has lowered the barriers and democratized the expertise required for deploying high-performance ML models. This technique suggests that ensembles often underlie top-performing solutions. As a result, the conventional technique suggests, integrating ensembling techniques, and constructing ensembles post-hoc from the pool of hyperparameters explored during Bayesian Optimization (BO).

It is noted that the true objective of CASH is not fully aligned with that of ensemble learning, despite the success of post-hoc ensembling techniques. In previous CASH approaches, the goal of BO has been to identify the optimal hyperparameter set h* that minimizes the expected validation error [symbol] (Y, f_{h*}(X)). However, the true objective of CASH is to identify a set of hyperparameters [h*₁, . . . , h*_{N}] that minimizes the ensemble generalization error

$${ℒ}_{Ensemble} ( Y , \frac{1}{N} {\sum }_{i = 0}^{N} {f}_{{h}_{i}^{*}} ( X ) ) .$$

It is well known that ensembles composed of individually strong and diverse models yield superior performance. Another conventional technique sought to address this by incorporating a diversity-seeking component into the BO objective. Specifically, it introduced a ‘diversity surrogate,’ i.e., a mechanism for predicting the pairwise diversity between two configurations not previously encountered. This strategy encourages the exploration of hyperparameters distinct from those in the current ensemble pool, thus enriching the solution's diversity. However, these conventional techniques still suffer from various problems, the functional form of diversity between the base models in ensemble model configuration and its effect on ensemble generalization error have not been considered. This leads to poor performance by an ensemble model configuration generated using the existing AutoML techniques.

Thus, there exists a need for technical solutions, such as improved methods and systems for determining optimal or recommended ensemble model configuration for performing predictions for a down-stream task while overcoming the aforementioned technical drawbacks.

### SUMMARY

Various embodiments of the present disclosure provide methods and systems for determining a recommended ensemble model configuration.

In an embodiment, a computer-implemented method for determining a recommended ensemble model configuration for a down-stream task is disclosed. The computer-implemented method performed by a server system includes accessing a validation dataset from a database associated with the server system. The computer-implemented method further includes generating one or more ensemble model configurations. Each ensemble model configuration of the one or more ensemble model configurations includes a subset of base models from a set of base models. The one or more ensemble model configurations represent all possible ensemble configurations for the set of base models. The computer-implemented method further includes iteratively performing a set of operations for each ensemble model configuration till predefined criteria are met. The set of operations includes (1) determining, by the subset of base models in the corresponding ensemble model configuration, a set of predictions based, at least in part, on the validation dataset; (2) computing, one or more prediction losses for each base model based, at least in part, on the set of predictions and the validation dataset; (3) computing a pairwise diversity loss metric for the subset of base models based, at least in part, on the set of predictions and the validation dataset, the pairwise diversity loss component being selected based on a model type of each base model; (4) fine-tuning, the subset of base models based, at least in part, on backpropagating the one or more prediction losses and the pairwise diversity loss metric. The computer-implemented method further includes determining the recommended ensemble model configuration from the one or more ensemble model configurations based, at least in part, on each ensemble model configuration comprising the subset of fine-tuned base models.

In another embodiment, a server system is disclosed. The server system includes a communication interface and a memory including executable instructions. The server system also includes a processor communicably coupled to the memory. The processor is configured to execute the instructions to cause the server system, at least in part, to access a validation dataset from a database associated with the server system. The server system is further configured to generate one or more ensemble model configurations. Each ensemble model configuration of the one or more ensemble model configurations includes a subset of base models from a set of base models. The one or more ensemble model configurations represent all possible ensemble configurations for the set of base models. The server system is further configured to determine iteratively performing a set of operations for each ensemble model configuration till predefined criteria are met. The set of operations includes (1) determining, by the subset of base models in the corresponding ensemble model configuration, a set of predictions based, at least in part, on the validation dataset; (2) computing, one or more prediction losses for each base model based, at least in part, on the set of predictions and the validation dataset; (3) computing a pairwise diversity loss metric for the subset of base models based, at least in part, on the set of predictions and the validation dataset, the pairwise diversity loss component being selected based on a model type of each base model; (4) fine-tuning, the subset of base models based, at least in part, on backpropagating the one or more prediction losses and the pairwise diversity loss metric. The server system is further configured to determine the recommended ensemble model configuration from the one or more ensemble model configurations based, at least in part, on each ensemble model configuration comprising the subset of fine-tuned base models.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a validation dataset from a database associated with the server system. The method further includes generating one or more ensemble model configurations. Each ensemble model configuration of the one or more ensemble model configurations includes a subset of base models from a set of base models. The one or more ensemble model configurations represent all possible ensemble configurations for the set of base models. The method further includes iteratively performing a set of operations for each ensemble model configuration till predefined criteria are met. The set of operations includes (1) determining, by the subset of base models in the corresponding ensemble model configuration, a set of predictions based, at least in part, on the validation dataset; (2) computing, one or more prediction losses for each base model based, at least in part, on the set of predictions and the validation dataset; (3) computing a pairwise diversity loss metric for the subset of base models based, at least in part, on the set of predictions and the validation dataset, the pairwise diversity loss component being selected based on a model type of each base model; (4) fine-tuning, the subset of base models based, at least in part, on backpropagating the one or more prediction losses and the pairwise diversity loss metric. The method further includes determining the recommended ensemble model configuration from the one or more ensemble model configurations based, at least in part, on each ensemble model configuration comprising the subset of fine-tuned base models.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present technology, reference is now made to the following descriptions taken in connection with the accompanying drawings in which:

FIG. 1 illustrates a schematic representation of an environment related to at least some example embodiments of the present disclosure;

FIG. 2 illustrates a simplified block diagram of a server system, in accordance with an embodiment of the present disclosure;

FIG. 3 illustrates a flow diagram depicting an architecture of a process for determining an optimal ensemble model configuration, in accordance with an embodiment of the present disclosure;

FIG. 4 illustrates a schematic representation of another environment related to at least some example embodiments of the present disclosure;

FIG. 5 illustrates a schematic representation of yet another environment related to at least some example embodiments of the present disclosure;

FIG. 6 illustrates a flow diagram depicting a method for determining the optimal ensemble model configuration for performing predictions for a down-stream task, in accordance with an embodiment of the present disclosure;

FIG. 7A, FIG. 7B, FIG. 7C, FIG. 7D, FIG. 7E, FIG. 7F, and FIG. 7G, collectively, illustrate various tables indicating various experimental results, in accordance with an embodiment of the present disclosure; and

FIG. 8 illustrates a flow diagram depicting a method for determining the recommended ensemble model configuration, i.e., the optimal ensemble model configuration for performing predictions for a down-stream task, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

For elucidatory purposes, ‘ensemble model configuration’ refers to the specific setup and configuration of individual Machine Learning (ML) models that combine to form an ensemble model. Herein, the individual ML models are also called the base models. An ensemble model configuration includes a set of ML models (called based models) in a specific configuration (of hyperparameters) unique to the ensemble model configuration. The ensemble model configuration determines how the individual models work together to produce a final prediction, aiming to improve overall performance by leveraging the strengths and compensating for the weaknesses of the individual models.

### Overview

Various embodiments of the present disclosure provide methods, systems electronic devices, and computer program products for determining optimal or recommended ensemble model configuration for performing predictions for a down-stream task.

As may be understood, the objective of a Combined Algorithm Selection and Hyperparameter (CASH) algorithm, given a dataset [symbol] ={ [symbol] ₜᵣₐᵢₙ, [symbol] ᵥₐₗ} and a predefined set of algorithms [symbol] =A¹, . . . , A^{K}, is to identify the optimal algorithm A* and its corresponding hyperparameters λ* that optimize a specified metric. For instance, in regression tasks, this often involves minimizing the Mean Square Error (MSE) given by [symbol] _{(x,y)˜D}_{ᵥₐₗ}[∥y−f_{A,λ}(x)∥²]. The resolution of CASH typically employs Bayesian optimization. In Bayesian optimization, a surrogate function (commonly a Gaussian Process) is fitted to all observed pairs of hyperparameters and algorithms (with the specified metric as the target). An acquisition function, such as the Upper Confidence Bound (UCB), is then utilized to guide the exploration of future configurations. This approach strategically balances exploration and exploitation, to optimize the objective function effectively.

As described earlier, the CASH problem has significantly evolved, with various methodologies enhancing its efficiency and broadening its application scope. For instance, approaches like Rising Bandits have improved the efficiency of CASH by iteratively eliminating less promising algorithms and concentrating resources on the most promising ones. On the other hand, another approach called TPOT diverges from traditional Bayesian Optimization, employing genetic programming to navigate the algorithm selection and hyperparameter tuning landscape. Furthermore, an Alternating Direction Method of Multipliers (ADMM)-based method deconstructs the CASH problem into sub-problems, which are then individually tackled using the ADMM.

Building on these foundations, subsequent approaches have addressed the weakness of CASH in incorporating Ensemble Learning. Notably, a post-hoc method for creating ensembles from all configurations has been explored during Bayesian Optimization. This method has been empirically demonstrated to be more robust against overfitting compared to traditional techniques such as boosting, bagging, and stacking. Consequently, this post-hoc approach to ensemble creation has been adopted by future Automatic Machine Learning (AutoML) systems. This conventional process involves starting with an empty ensemble and iteratively adding models (with replacement) that are orthogonal to the current ensemble set and that enhance validation performance. It becomes evident that the true objective of ensemble-oriented CASH is to minimize the ensemble generalization error, denoted as

$${ℒ}_{Ensemble} ( Y , \frac{1}{N} {\sum }_{i = 0}^{N} {f}_{{h}_{i}} ( X ) ) , {h}_{i} = ( {A}^{i} , {λ}^{i} ) .$$

However, a misalignment exists with this objective in the standard Bayesian Optimization (BO) approach utilized by previous conventional approaches, as BO traditionally proposes hyperparameters expected to yield promising individual performance, without considering their collective performance in an ensemble. While Ensemble Optimization aims to rectify this by considering the interaction of hyperparameters with the existing ensemble pool, this method has empirically underperformed in comparison to simple post-hoc ensembles. This underperformance is attributed to its unstable optimization process, which is significantly affected by the addition of any sub-optimal configuration to the ensemble pool.

In response to the misalignment between the actual objectives of CASH and the BO framework utilized by prior approaches, Diversity-aware Bayesian Optimization (DivBO) introduced an explicit search for diversity within the BO objective function. It accomplished this by establishing an additional surrogate function, designed to predict the diversity between two unseen configurations, formulated as

$$D ( {h}_{i} , {h}_{j} ) = \frac{1}{\vert {D}_{val} \vert} {𝔼}_{( x , y ) ∼ {𝒟}_{val}} {‖ {f}_{{h}_{i}} ( x ) - {f}_{{h}_{j}} ( x ) ‖}_{2}$$

for classification tasks. The acquisition function guiding the hyperparameter search became a linear combination of the traditional “performance” surrogate and this new diversity surrogate. This approach to diversity incentivizes the exploration of hyperparameters that yield predictions distinct from those currently in the ensemble pool (i.e., the one or more ensemble model configurations generated using the set of base models). While DivBO represented an innovative step towards authentic ensemble learning, it was not devoid of limitations. It's evident that overemphasizing DivBO's notion of diversity could potentially degenerate the pool of learners, resulting in models that predict all classes incorrectly but remain distinct from others in the ensemble. DivBO did not thoroughly examine the functional form of diversity and its effect on ensemble generalization error. The intricate relationship between diversity and ensemble performance constitutes a significant body of ensemble learning literature, one that has been largely overlooked in the CASH methods until now.

In other words, the primary limitation of DivBO is its inability to identify the specific type of diversity optimal for minimizing the true target: the ensemble generalization error. As a result, DivBO does not fully bridge the gap in current CASH approaches, underscoring the need for further development of a Bayesian optimization framework that directly optimizes for ensemble risk.

Various embodiments of the present disclosure provide methods, systems, electronic devices, and computer program products for determining a recommended ensemble model configuration. The server system includes a processor and a memory.

In a non-limiting implementation, the server system is configured to access a validation dataset from a database associated with the server system. Further, the server system is configured to generate one or more ensemble model configurations. Here, each ensemble model configuration of the one or more ensemble model configurations includes a subset of base models from a set of base models. Herein, the one or more ensemble model configurations represent all possible ensemble configurations for the set of base models. In an embodiment, the subset of base models in each ensemble model configuration of the one or more ensemble model configurations is randomly selected from the set of base models.

Furthermore, the server system is configured to iteratively perform a set of operations for each ensemble model configuration till predefined criteria are met. The set of operations includes determining, by the subset of base models in the corresponding ensemble model configuration, a set of predictions based, at least in part, on the validation dataset. Further, the set of operations includes computing one or more prediction losses for each base model based, at least in part, on the set of predictions and the validation dataset. In an embodiment, one or more prediction losses are computed using one or more loss functions associated with each base model of the subset of base models.

Furthermore, the set of operations includes computing a pairwise diversity loss metric for the subset of base models based, at least in part, on the set of predictions and the validation dataset. Herein, the pairwise diversity loss component is selected based on a model type of each base model. For computing the pairwise diversity loss metric, the server system is configured to select a pairwise diversity loss component. Herein, the pairwise diversity loss component is selected based on a model type of type of each base model in the subset of base models in the corresponding ensemble model configuration. Then, the server system is configured to generate the pairwise diversity loss metric for the subset of base models. Here, the pairwise diversity loss is generated based, at least in part, on the pairwise diversity loss component, the set of predictions, and the validation dataset.

Moreover, the set of operations includes fine-tuning, the subset of base models based, at least in part, on backpropagating the one or more prediction losses and the pairwise diversity loss metric. For fine-tuning the subset of base models, the server system is configured to compute an ensemble generalization error for the subset of base models. The ensemble generalization error is computed based, at least in part, on the one or more prediction losses and the pairwise diversity loss metric. Then, the server system is configured to fine-tune the subset of base models based, at least in part, on backpropagating the ensemble generalization error.

The server system is further configured to determine the recommended ensemble model configuration from the one or more ensemble model configurations. Here, the determination of the recommended ensemble model configuration is based, at least in part, on each ensemble model configuration, including the subset of fine-tuned base models. For determining the recommended ensemble model configuration, the server system is configured to compute an ensemble performance of each ensemble model configuration. Here, the ensemble performance is computed based, at least in part, on the validation dataset and the subset of fine-tuned base models of each ensemble model configuration. Then, the server system is configured to select the recommended ensemble model configuration from the one or more ensemble model configurations. Here, the recommended ensemble model configuration is selected based, at least in part, on the ensemble performance of each ensemble model configuration. Herein, the recommended ensemble model configuration has the highest ensemble performance

Furthermore, the server system is configured to receive an ensemble model generation request for generating the recommended ensemble model configuration for performing a down-stream task. Then, the server system is configured to access a training dataset from the database associated with the server system. Moreover, the server system is configured to determine a data type of the training dataset and the validation dataset. Then, the server system is configured to select the set of base models from a set of available models based, at least in part, on the down-stream task and the data type.

Further, the server system is configured to generate a set of features based, at least in part, on the training dataset. Furthermore, the server system is configured to determine feature importance of each feature in the set of features. Then, the server system is configured to extract a set of important features from the set of features based, at least in part, on the feature importance of each feature and an importance threshold. Moreover, the server system is configured to train the set of base models based, at least in part, on the training dataset and the set of important features. The server system is further configured to receive a request for generating a prediction for a downstream task. Then, the server system is configured to generate the prediction for the downstream task utilizing the recommended ensemble model configuration.

Various embodiments of the present disclosure offer multiple advantages and technical effects. For instance, the present disclosure aims to solve the technical problem of how to effectively minimize the ensemble generalization error by deriving a pairwise diversity loss component which allows to decompose standard loss functions into components reflecting average individual model performance and pairwise diversity. This methodology is theoretically robust and practically feasible, in effectively minimizing the ensemble generalization error-a goal that is not fully realized by previous CASH approaches.

It solves the problem by introducing the pairwise diversity loss component, a BO approach explicitly designed to identify hyperparameters that minimize ensemble risk by optimally balancing individual model performance with model diversity. This is the first application of Bayesian optimization within the CASH framework that explicitly aims to minimize the ensemble's generalization error, setting a new precedent in the field.

It has been described later that the traditional risk associated with ensemble models in both regression and classification tasks (including mean square, mean absolute, cross-entropy, and Brier score) can be upper-bounded by components of individual model performance and pairwise diversity. This revelation enables the framework provided in the proposed approach to conceptualize “optimal diversity”, a critical factor overlooked by prior approaches.

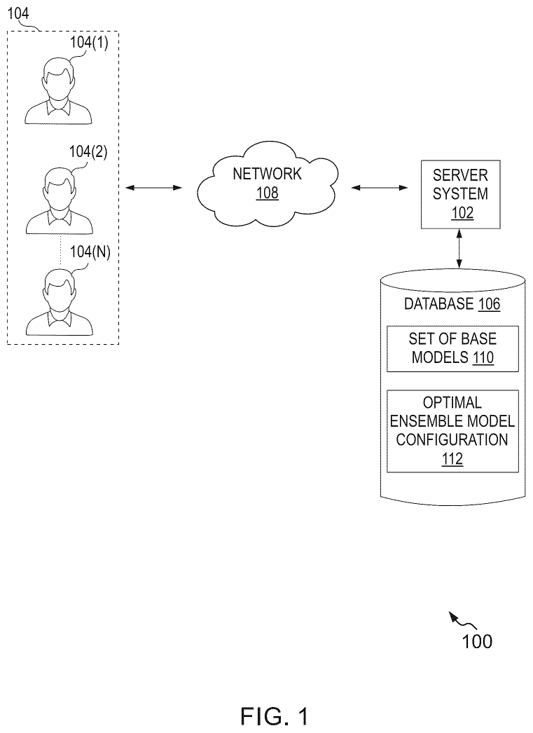

Various example embodiments of the present disclosure are described hereinafter with reference to FIG. 1 to FIG. 7A-FIG. 7G.

FIG. 1 illustrates a schematic representation of an environment 100 related to at least some example embodiments of the present disclosure. Although the environment 100 is presented in one arrangement, other embodiments may include the parts of the environment 100 (or other parts) arranged otherwise depending on, for example, generating one or more ensemble model configurations, determining an optimal (or recommended) ensemble model configuration, and the like.

The environment 100 generally includes a plurality of entities, such as a server system 102, a plurality of users 104(1), 104(2), . . . 104(N) (collectively referred to hereinafter as a ‘plurality of users 104’ or simply, ‘users 104’), a database 106, each coupled to, and in communication with (and/or with access to) a network 108. Herein, it may be noted that ‘N’ is a non-zero natural number and may be different for each distinct entity.

Conventionally, Combined Algorithm Selection and Hyperparameter Optimization (CASH) has been utilized to perform the Automatic Machine Learning (AutoML) task for determining an optimal (or recommended) ensemble model configuration for performing predictions related to a down-stream task. However, as described earlier, the CASH problem is pivotal in the field of AutoML. Most conventional solutions to this problem, involve combining Bayesian Optimization (BO) with post-hoc ensemble building to create advanced AutoML systems. BO typically focuses on identifying a singular algorithm and its hyperparameters that outperform all other configurations. Recent developments have highlighted an oversight in prior CASH methods, i.e., the lack of consideration for diversity among the base learners (or base models) of the ensemble. This oversight was overcome by explicitly injecting the search for diversity into the traditional CASH problem. However, despite recent developments, BO's limitation lies in its inability to directly optimize ensemble generalization error, offering no theoretical assurance that increased diversity correlates with enhanced ensemble performance.

Therefore, the above-mentioned technical problems, among other problems, are addressed by one or more embodiments implemented by the server system 102 and the methods thereof provided in the present disclosure. It should be noted that the server system 102 is configured to determine an optimal (or recommended) ensemble model configuration 112 for performing a prediction related to a down-stream task.

In one embodiment, the server system 102 may be used by a managing entity to train one or more ensemble model configurations and a set of base models 110 (referred hereinafter interchangeably as ‘base models 110’) for generating predictions related to a down-stream task. In a non-limiting implementation, the managing entity may be any individual, representative of a person, an institution, an organization, a corporate entity, a non-profit organization, a financial institution, a bank, medical facilities (e.g., hospitals, laboratories, etc.), educational institutions, government agencies, telecom industries, or the like. In an example, the managing entity may be an administrator of the server system 102.

Examples of the down-stream task may include, but are not limited to, speech recognition, image classification, email spam detection, performing medical diagnosis, fraud detection, risk management, charge-back decision-making systems, payment authorization systems, data analytics, credit card scoring systems, cross-border transaction management systems, consumer segmenting, or the like.

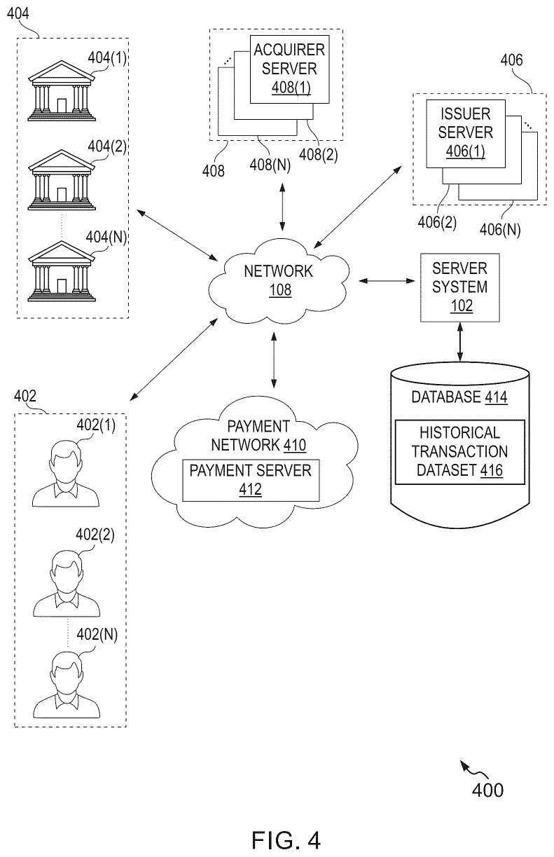

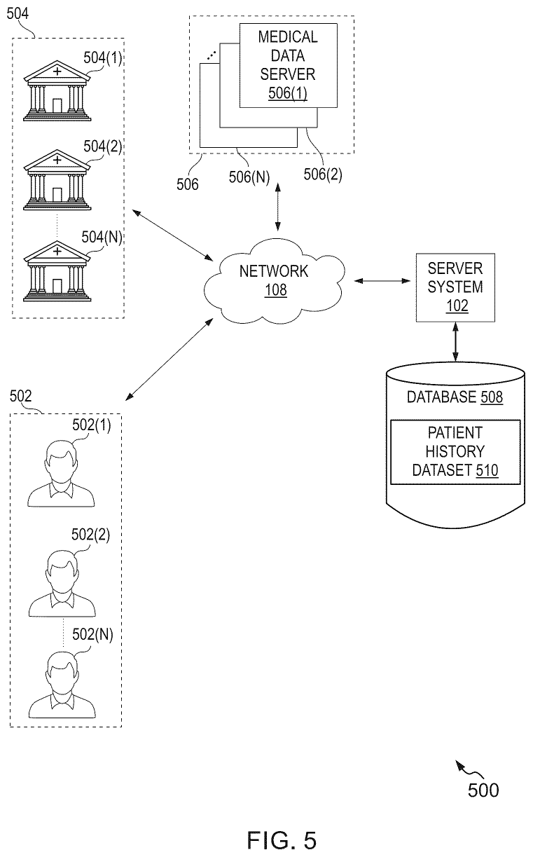

In another embodiment, the users (e.g., users 104) may correspond to individuals whose data is used for training the models. For instance, the users 104 may be patients who are undergoing treatment for certain diseases (as described later with reference to FIG. 5). Data generated corresponding to such patients can be used to learn and understand the experience of the patients at a particular clinical center. Thus, such data is used to train base models 110 associated with an individual ensemble model configuration to identify diseases and diagnoses. For example, classifying different diseases, such as cancer using images, predicting the progression of pre-diabetes, predicting response to depression treatment, etc. In another instance of a payment industry (as described later with reference to FIG. 4), the users 104 may be cardholders, account holders, merchants, consumers, issuers, acquirers, banks, third-party users, financial institutions, or the like. Data related to such individuals include historical financial transaction-related data, income-related data, expenditure-related data, and the like. Such data can be used to train base models 110 associated with the individual ensemble model configuration to predict the income of an individual, predict financial frauds and risks, perform payment authorization operations, and the like.

In some embodiments, the users 104 may use their corresponding electronic devices (not shown in figures) to access a mobile application or a website associated with the hospital, issuing bank, or any third-party payment application to perform a health-related operation or payment transaction. Data related to the users 104 may be collected from their corresponding user devices. In various non-limiting examples, the electronic devices may refer to any electronic devices, such as, but not limited to, Personal Computers (PCs), tablet devices, smart wearable devices, Personal Digital Assistants (PDAs), voice-activated assistants, Virtual Reality (VR) devices, smartphones, laptops, and the like.

The network 108 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or users 104 illustrated in FIG. 1, or any combination thereof.

Various entities in the environment 100 may connect to the network 108 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 108 may utilize a secure protocol (e.g., Hypertext Transfer Protocol (HTTP), Secure Socket Lock (SSL), and/or any other protocol, or set of protocols for communicating with the various entities depicted in FIG. 1.

In a specific embodiment, the server system 102 may facilitate the managing entity such as an institution involved in determining the optimal (or recommended) ensemble model configuration 112 to perform the down-stream task. In an embodiment, the server system 102 may be coupled to the database 106. In one embodiment, the database 106 may be incorporated in the server system 102 or maybe an individual entity connected to the server system 102 or maybe a database stored in cloud storage. In various non-limiting examples, the database 106 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the server system 102 with access to the database 106. In one implementation, the database 106 may be viewed, accessed, amended, updated, and/or deleted by an administrator (not shown) such as the managing entity associated with the server system 102 through a database management system (DBMS) or relational database management system (RDBMS) present within the database 106.

In an embodiment, the database 106 may store the set of base models 110. Hereinafter, the set of base models 110 may interchangeably be referred to as ‘base models’, ‘base learners’, or ‘individual models’. The set of base models 110 are the constituent ML models that constitute an ensemble model configuration. Each base model of the set of base models 110 is trained independently and contributes to the final prediction made by the ensemble model configuration. Examples of base models 110 include but are not limited to decision trees, support vector machines, neural networks, or any other ML models. The primary goal of combining these base models 110 in the ensemble model configuration is to enhance the overall predictive performance of the predictive process by aggregating the predictions of the base models 110, thereby reducing errors and increasing robustness compared to using a single model.

In an embodiment, the server system 102 is configured to receive an ensemble model generation request for determining a prediction for a down-stream task. In response, the server system 102 is configured to generate one or more ensemble model configurations such that each ensemble model configuration includes a subset of base models (extracted from the set of base models 110). Herein, the one or more ensemble model configurations represent all possible ensemble configurations for the set of base models 110.

Then, the server system 102 is configured to iteratively perform a set of operations for each ensemble model configuration till predefined criteria are met. The set of operations includes determining, by the subset of base models 110 in the corresponding ensemble model configuration, a set of predictions. Further, the set of operations includes computing, one or more prediction losses for each base model based, at least in part, on the set of predictions. Further, the set of operations includes computing a pairwise diversity loss component for the subset of base models 110 based, at least in part, on the set of predictions. Herein, the pairwise diversity loss component is selected based on a model type of each base model. Furthermore, the set of operations includes optimizing, the subset of base models 110 based, at least in part, on backpropagating the one or more prediction losses and the pairwise diversity loss component.

Upon completion of the iterative process, the server system 102 is configured to determining an ensemble performance of each ensemble model configuration using the subset of optimized base models 110 (i.e., the trained base models 110) of each ensemble model configuration. Thereafter, the server system 102 is configured to determine the optimal ensemble model configuration 112 from the one or more ensemble model configurations based, at least in part, on the ensemble performance of each ensemble model configuration. Herein, the optimal ensemble model configuration 112 is selected based on the same having the highest ensemble performance among its peer ensemble model configurations.

In an embodiment, the server system is configured to receive a request for generating a prediction for a down-stream task. Then, the server system is configured to generate, by the recommended ensemble model configuration, the prediction for the down-stream task.

In an embodiment, it may be noted that the methods and systems proposed in the present disclosure can be used in any domain or industry to perform any down-stream tasks. The industries may include healthcare, retail, media, travel, crime detection, financial industry, and the like.

It should be understood that the server system 102 is a separate part of the environment 100, and may operate apart from (but still in communication with, for example, via the network 108) any third-party external servers (to access data such as the training datasets to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices are shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 108, which may be specifically configured, via executable instructions, to perform steps as described herein, and/or embodied in at least one non-transitory computer-readable media.

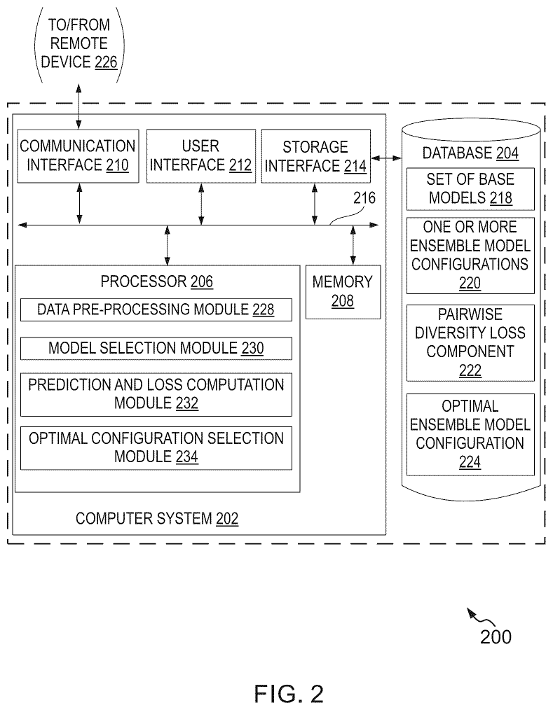

FIG. 2 illustrates a simplified block diagram of a server system 200, in accordance with an embodiment of the present disclosure. The server system 200 is identical to the server system 102 of FIG. 1. In some embodiments, the server system 200 is embodied as a cloud-based and/or Software as a Service (SaaS)-based architecture.

The server system 200 includes a computer system 202 and a database 204. The computer system 202 includes at least one processor 206 (herein, referred to interchangeably as ‘processor 206’) for executing instructions, a memory 208, a communication interface 210, a user interface 212, and a storage interface 214. One or more components of the computer system 202 communicate with each other via a bus 216. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities.

In some embodiments, the database 204 is integrated into the computer system 202. In one embodiment, the database 204 is substantially similar to the database 106 of FIG. 1. In one non-limiting example, the database 204 is configured to store a set of base models 218, one or more ensemble model configurations 220, a pairwise diversity loss component 222, an optimal ensemble model configuration 224, and the like. Herein, the set of base models 218 and the optimal ensemble model configuration 224 are identical to the set of base models 110 and the optimal ensemble model configuration 112 of FIG. 1.

In a non-limiting example, the set of base models 218 are the constituent ML models that constitute an ensemble model configuration. Each base model of the set of base models 218 (referred to hereinafter as “base models” 218) is trained independently and contributes to the final prediction made by the ensemble model configuration. Examples of base models 218 include but are not limited to decision trees, support vector machines, neural networks, or any other ML models. The primary goal of combining these base models 218 in the ensemble model configuration is to enhance the overall predictive performance of the predictive process by aggregating the predictions of the base models 218, thereby reducing errors and increasing robustness compared to using a single model. It is noted that the remaining constituents of the database 204 are described later.

Further, the computer system 202 may include one or more hard disk drives as the database 204. The user interface 212 is an interface, such as a Human Machine Interface (HMI) or a software application that allows users 104 such as an administrator to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute operations for determining the optimal (or recommended) ensemble model configuration 224, and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing various operations described herein. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 226, such as electronic devices of the users 104, or communicating with any entity connected to the network 108 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 228, a model selection module 230, a prediction and loss computation module 232, and an optimal configuration selection module 234. It should be noted that components, described herein, such as the data pre-processing module 228, the model selection module 230, the prediction and loss computation module 232, and the optimal configuration selection module 234 can be configured in a variety of ways, including electronic circuitries, digital arithmetic, and logic blocks, and memory systems in combination with software, firmware, and embedded technologies. Moreover, it may be noted that the data pre-processing module 228, the model selection module 230, the prediction and loss computation module 232, and the optimal configuration selection module 234 may be communicably coupled with each other to exchange information with each other for performing the one or more operations facilitated by the server system 200.

In an embodiment, the data pre-processing module 228 includes suitable logic and/or interfaces for receiving an ensemble model generation request for determining a prediction for a down-stream task. Herein, the down-stream task may refer to any application where the requested ensemble model is used to perform predictions. In response to this request, the data pre-processing module 228 is configured to access a training dataset and a validation dataset from the database 204 associated with the server system 200.

The term ‘training dataset’ may refer to a collection of data (or data samples/observations) used to train ML models. This dataset includes input data and the corresponding correct outputs (labels or target values) that the model uses to learn the underlying patterns and relationships within the data. During the training process, the model iteratively adjusts (or optimizes) its parameters (or hyperparameters) based on the input data and feedback from its predictions compared to the actual outputs, aiming to minimize prediction errors and improve accuracy. The term ‘validation dataset’ may refer to a subset of data used to evaluate the performance of the ML model during the training process. Unlike the training dataset, the validation dataset is not used to train the model but to monitor its performance and tune hyperparameters. By assessing the model on the validation dataset, one can detect issues such as overfitting or underfitting, ensuring that the model generalizes well to unseen data. The validation dataset helps in making decisions about model adjustments and selecting the best version of the model before final testing. As used herein, the terms ‘data point’, ‘data sample’, and ‘observation’, may be used interchangeably, and refer to a single instance or observation within the training or validation dataset.

Further, the data pre-processing module 228 is configured to generate a set of features based, at least in part, on the training dataset. In particular, featurization techniques may be utilized to generate the set of features. In some instances, the data pre-processing module 228 may utilize existing featurization techniques such as one-hot encoding, logarithmic transformation, binning, and so on to generate the features described herein. It is noted that since these techniques are well-known in the art, they have not been explained here for the sake of brevity.

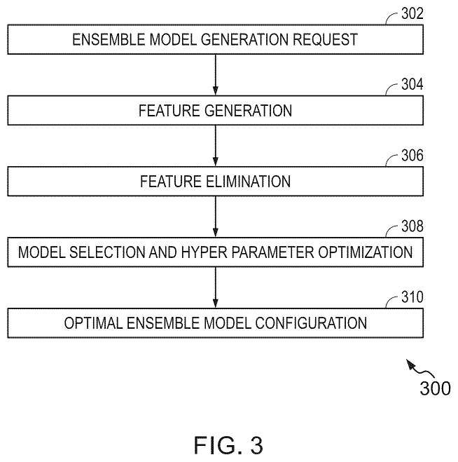

Further, the data pre-processing module 228 is configured to determine the feature importance of each feature in the set of features and extract a set of important features from the set of features based, at least in part, on the feature importance of each feature and an importance threshold. This aspect has been described later with reference to FIG. 3.

For instance, the data pre-processing module 228 may be configured to perform operations such as removing noise, feature engineering (also referred to as featurization or feature generation), feature selection, data cleaning, handling missing values, normalizing or scaling data, analyzing characteristics of the data, and converting the training and validation dataset into a format that AI or ML models can process. Since these operations are well known in the art, the same has not been described herein for the sake of brevity.

In an embodiment, the model selection module 230 includes suitable logic and/or interfaces for selecting the set of base models 218 from a set of available models. In particular, the set of base models 218 is selected based, at least in part, on the down-stream task and a data type of the training dataset and the validation dataset. More specifically, when an ensemble model generation request for generating the recommended ensemble model configuration for performing a down-stream task is received, the model selection module 230 determines a data type of the training dataset and the validation dataset. Then, the model selection module 230 selects the set of base models from a set of available models based, at least in part, on the down-stream task and the data type.

As may be appreciated, since different types of models have different capabilities and strengths, the model selection module 230 can select suitable models for the corresponding data type of the training and validation datasets to ensure that the said selected models are capable of learning from this data. For example, if the dataset belongs to transaction data in tabular form which is highly imbalanced in terms of labels, then the model selection module 230 will select those base models 218 that are capable of inferencing from such an imbalanced dataset. Examples of this have been provided later with reference to FIG. 4 and FIG. 5.

In another embodiment, the model selection module 230 is configured to train the set of base models 218 based, at least in part, on the set of important features and the training dataset. Since the training process of base models 218 is well-known, it has not been described for the sake of brevity.

Further, the model selection module 230 is configured to generate one or more ensemble model configurations 220. Such that each ensemble model configuration of the one or more ensemble model configurations 220 includes a subset of base models. Herein, the subset of base models may be randomly selected by the model selection module 230 from the set of base models 218. Herein, the one or more ensemble model configurations 220 represent all possible ensemble configurations for the set of base models 218.

In an embodiment, the prediction and loss computation module 232 includes suitable logic and/or interfaces for iteratively performing a set of operations for each ensemble model configuration till predefined criteria are met. In some scenarios, the predefined criteria may refer to a fixed number of iterations, a stage during the iterative process where the loss component gets saturated (i.e., no further reduction in loss takes place with successive iterations), and so on. Herein, the set of operations includes determining, by the subset of base models in the corresponding ensemble model configuration, a set of predictions based, at least in part, on the validation dataset. In an implementation, these predictions are performed for the down-stream task using the data samples present in the validation dataset.

Further, the set of operations includes computing, one or more prediction losses for each base model based, at least in part, on the set of predictions and the validation dataset. The one or more prediction losses may be computed using one or more loss functions traditionally associated with each base model of the subset of base models.

Further, the set of operations includes computing a pairwise diversity loss component (e.g., the pairwise diversity loss component 222) for the subset of base models based, at least in part, on the set of predictions and the validation dataset. Herein, the pairwise diversity loss component 222 is selected based on the model type of each base model. As described earlier, different types of pairwise diversity loss components 222 are suitable for different model types. Thus, the prediction and loss computation module 232 automatically selects the best or appropriate pairwise diversity loss component 222 for the ensemble configuration being tested or checked. The goal of the pairwise diversity loss component 222 is to introduce diversity in the learnings of different ensemble model configurations. This aspect has been described earlier in the present disclosure.

Further, the set of operations includes optimizing, the subset of base models based, at least in part, on backpropagating the one or more prediction losses and the pairwise diversity loss component 222. It is understood that by fine-tuning or optimizing the models within the selected ensemble model configuration, the impact of diversity on the models can be accounted for. It is noted that the various operations have been described in detail later with reference to FIG. 3.

In an embodiment, the optimal configuration selection module 234 includes suitable logic and/or interfaces for determining an ensemble performance of each ensemble model configuration based, at least in part, on the validation dataset and the subset of fine-tuned base models of each ensemble model configuration. In other words, once different ensemble model configurations have been fine-tuned or optimized for the highest performance through the various iterations, the overall performance of each ensemble model configuration is determined.

Further, the optimal configuration selection module 234 is configured to determine the optimal ensemble model configuration 224 (also, interchangeably called recommended ensemble model configuration 224) from the one or more ensemble model configurations 220 based, at least in part, on the ensemble performance of each ensemble model configuration. Herein, the optimal ensemble model configuration 224 is selected based on its ensemble performance being the highest within the one or more ensemble model configurations 220. It is noted that this aspect has been described in detail later with reference to FIG. 3.

FIG. 3 illustrates a flow diagram depicting an architecture of a process 300 for determining the optimal ensemble model configuration 224, in accordance with an embodiment of the present disclosure.

At step 302, the process 300 includes receiving an ensemble model generation request by the server system 200. The ensemble model generation request may be received from any entity interested in creating the optimal ensemble model configuration 224 for performing predictions related to a down-stream task.

At step 304, the process 300 includes the feature generation stage. The feature generation stage includes accessing the training dataset and validation dataset from the database 204. Then, the set of base models 218 is selected from a set of available models based, at least in part, on the down-stream task and a data type of the training dataset and the validation dataset. It is noted that the data type of these datasets indicates the type of data on which inference has to be performed. For example, if the data type is tabular heterogeneous data, then the server system 200 is configured to select only those models from available models as base models 218 that have proven performance on the tabular heterogeneous data. In other words, by relying on the data type of the training and validation dataset to filter base models 218, the server system 200 can save time and resources since there is no need to check unsuitable models while generating the one or more ensemble model configurations 220. Then, a set of features is generated using the training dataset.

At step 306, the process 300 includes the feature elimination stage. In this stage, the feature importance of each feature in the set of features is computed. Then, this feature importance is used to extract a set of important features from the set of features. In one scenario, features that have a corresponding feature importance at least equal to an importance threshold may be selected to be a part of the set of importance features. It is noted that various feature elimination pipelines may be utilized to perform the feature elimination stage. In a non-limiting feature elimination pipeline, 10% random noise features may be added to each feature in the set of features. Then, an ML model such as a Categorical Boosting (CatBoost) model be trained to determine the feature importance of each feature. Subsequently, all features that have lesser importance than the minimum importance of the features with random noise may be eliminated. Then, Recursive Feature Elimination may be applied to all features with importance in between the maximum and minimum importance of the features with random noise. Further, a metric such as the Spearman or Pearson correlation may be computed. Thereafter, all features that have Spearman or Pearson correlation greater than the importance threshold such as 0.95, i.e., user-defined, and have lesser importance can be eliminated. Thus, the remaining features can be added to the set of important features. Later, the set of base models 218 can be trained using the set of important features. It is noted that feature elimination pipelines are well-known in the art, therefore the same are not explained here in detail for the sake of brevity.

At step 308, the process 300 includes the model selection and hyperparameter optimization stage. To describe the model selection and hyperparameter optimization stage, at first the Diversity-aware Bayesian optimization (DivBO) has to be discussed.

DivBO is the diversity-aware method for addressing the CASH problem within the realm of ensemble learning, employing BO. DivBO introduced diversity into the BO process through a two-fold approach: 1) establishing a diversity metric that quantified the similarity or dissimilarity between two distinct configurations, and 2) formulating a modified acquisition function. This acquisition function aimed to propose configurations that not only demonstrated promising performance but also maintained a level of diversity from existing members of the ensemble, thereby enriching the ensemble's overall predictive power.

DivBO incorporates a pairwise diversity metric Div(hᵢ, hⱼ) which has been empirically demonstrated to enhance the diversity of neural networks. Here, hᵢ represents the joint configuration of the algorithm aᵢ and its corresponding hyperparameters, λᵢ. The pairwise diversity metric is defined by Eqn. 1 given below:

$$Div ( {h}_{i} , {h}_{j} ) = \frac{1}{\sqrt{2} \vert {𝒟}_{val} ‖} {\sum }_{( x , y ) ∼ {𝒟}_{val}} {‖ {f}_{{h}_{i}} ( x ) - {f}_{{h}_{j}} ( x ) ‖}_{2} \qquad Eqn . 1$$

This specific metric, particularly in classification tasks, encourages the Bayesian Optimization process to consider configurations whose predictions significantly diverge from those previously selected in the temporary ensemble pool of the one or more ensemble model configurations 220. In this context, [symbol] ᵥₐₗ denotes the validation dataset, and fₕ_{ᵢ}(x) represents the learner associated with configuration, hᵢ, which was fitted on the training dataset Dₜᵣₐᵢₙ. To model the diversity between two unseen configurations, (hᵢ, hⱼ). DivBO employs a second surrogate function. This diversity surrogate, akin to traditional BO, maps unseen configurations (hᵢ, hⱼ) to the predictive mean and variance of pair-wise diversity.

The diversity surrogate [symbol] _{div} consists of an ensemble of lightGBM models, selected over the traditional Gaussian Process for its substantial computational efficiency −O(|D|² log|D|) as compared to O(|D|³). Owing to the symmetry of the diversity metric. Div (hᵢ, hⱼ)=Div (hⱼ, hₗ), the number of observations |D| leads to a quadratic increase in training data points, amounting to |D|².

DivBO maintains a temporary pool of ensembles, i.e., the one or more ensemble model configurations 220, denoted as [symbol] , which includes all base learners that could potentially form part of the final ensemble, i.e., the desired or the optimal ensemble model configuration 224. This ensemble pool is constructed using the traditional ad-hoc method, applied across the entire history of observations or data samples. It is noted that this process is well-known, therefore it is not described herein. The acquisition function is designed to propose configurations that are distinct from those in the current observation pool. The diversity acquisition function is defined by Eqn. 2 given below:

$${α}_{div} ( h ) = \frac{1}{N} {\sum }_{l = 0}^{N} {min}_{θ ∈ 𝒫} {M}_{div}^{i} ( h , θ ) \qquad Eqn . 2$$

Here,

$${ℳ}_{div}^{i} ( h , θ )$$

represents the i^{th} sampled value from the output distribution of our diversity surrogate [symbol] given a pair of ensemble model configurations (θ, h). The final acquisition function is the average of N minimums via sampling. DivBO's ultimate acquisition function is a weighted linear combination of the traditional performance based acquisition function and the diversity acquisition function. It may be expressed by Eqn. 3 given below:

$${α}_{DivBO} ( h ) = {α}_{perf} ( h ) + w {α}_{div} ( h ) , w = β ( sigmoid ( γ t ) - 0 \text{.5} ) \qquad Eqn . 3$$

In the above equation, w signifies the weight of the diversity acquisition function, with t representing the number of BO iterations. The parameters β and γ are hyperparameters that control the behavior of the acquisition function, ensuring a balanced integration of performance and diversity in the model selection process.

As may be appreciated, upon closely examining DivBO, its shortcomings become pronounced. A significant limitation is the absence of a theoretical framework guaranteeing the minimization of the ensemble generalization error. Relying solely on increasing DivBO's diversity metric can inadvertently result in degenerate solutions that, while diverse are consistently inaccurate. Moreover, the optimality of DivBO's where a learner can precisely predict the label or target. This casts doubt on the necessity of optimizing DivBO's diversity metric, which could unnecessarily push correct predictions away from the true target. While extensive study has been conducted to elucidate the relationship between diversity and ensemble generalization error, this intricate interplay has been largely overlooked in the conventional CASH techniques, including DivBO.

To that end, the various embodiments proposed by the present disclosure aim to bridge this gap, integrating insights from both the CASH domain and diversity-based ensemble learning literature.

Building upon the existing literature on diversity-based ensembles, the proposed approach provides a theoretical framework that upper-bounds the loss of an ensemble in terms of the average performance of individual models and a pairwise diversity metric using the pairwise diversity loss component 222. Mathematically, this relationship may be delineated using the Eqn. 4 given below:

$${ℒ}_{Ensemble} ( Y , \frac{1}{N} {\sum }_{l = 0}^{N} {f}_{{h}_{i}} ( X ) ) \leq \frac{1}{N} {\sum }_{i = 0}^{N} {ℒ}_{i} ( Y , {f}_{{h}_{i}} ( X ) ) + {\sum }_{i = 0}^{N} {\sum }_{j \neq i} Div ( Y , {f}_{{h}_{i}} ( X ) , {f}_{{h}_{j}} ( X ) ) \qquad Eqn . 4$$

The pairwise diversity loss component 222 (hereinafter, interchangeably referred to as optimal diversity), then, is defined as OptDiv(Y, fₕ_{ᵢ}, fₕ_{ⱼ})=Div(Y, fₕ_{ᵢ}(X), fₕ_{ⱼ}(X))+Div(Y, fₕ_{ⱼ}(X), fₕ_{ᵢ}(X)), serving as the target for the diversity surrogate under the standard DivBO framework. Distinct from prior diversity-based ensemble learning approaches, the server system 200 opts to upper-bound the ensemble generalization error with a pairwise diversity metric. This choice facilitates integration into the DivBO framework within the CASH domain, thereby providing a scalable solution that can be implemented on top of the existing conventional CASH-based solutions deployed. By decomposing the ensemble generalization error in the above manner, the server system 200 ensures that minimizing the individual model performance and the pairwise diversity loss component 222 or the Optimal Diversity metric (i.e., OptDiv(Y, fₕ_{ᵢ}, fₕ_{ⱼ}) within the Bayesian Optimization framework guarantees an improvement in the ensemble's overall performance. In other words, by fine-tuning the subset of base models belonging to each of the one or more ensemble model configurations 220 in the ensemble pool, the overall performance of each ensemble model configuration can be improved.

It is pertinent to note that the pairwise diversity loss component 222 is distinct from DivBO's because it is not only a function of the learners fₕ_{ᵢ}/fₕ_{ⱼ}, but it also depends on the labels or target (depending on classification or regression task). Herein, learners refer to the base models 218 within a specific ensemble model configuration. In other words, the pairwise diversity loss component 222 is selected based on the model type of each base model selected for the down-stream task. Here, the example of classification and regression-based task is employed to describe this aspect later on. As may be appreciated, intuitively it makes sense that a Diversity metric should not be independent of the task at hand. The exact form of the diversity metric varies according to the task and the loss function targeted for optimization.

To describe this aspect, standard loss functions for base models 218 such as Mean Square Error (MSE) and Mean Absolute Error (MAE) for regression tasks, along with Cross-entropy (CE) and Brier score (BS) for classification tasks have been considered.

In regression problems, the MSE is commonly chosen for the base models 218 as the metric to be minimized, with the ensemble generalization error as

$${𝔼}_{( x , y ) ∼ {𝒟}_{val}} [ {\vert y - \frac{1}{N} {\sum }_{i = 0}^{N} {f}_{{h}_{i}} ( x ) \vert}^{2} ] .$$

Previous research has noted that the discrepancy between ensemble generalization error and the average performance of individual models is proportional to the sample variance V̅a̅r̅(fₕ), which can be considered a form of diversity metric.

Mathematically the ensemble generalization error for a specific ensemble model configuration made up of a subset of base models can be given by Eqn. 5. It is noted that Eqn. 5 decomposes the ensemble generalization error into individual model error for each base model in the subset of base models and pairwise diversity (i.e., the pairwise diversity loss component 222).

$${𝔼}_{( x , y ) ∼ {𝒟}_{val}} [ \vert y - \frac{1}{N} {\sum }_{i = 0}^{N} {f}_{{h}_{i}} ( x ) {\vert}^{2} ] = \frac{1}{{N}^{2}} {E}_{( x , y ) ∼ {𝒟}_{val}} [ {\vert {\sum }_{i = 0}^{N} ( y - {f}_{{h}_{i}} ( x ) ) \vert}^{2} ] = \frac{1}{{N}^{2}} {𝔼}_{( x , y ) ∼ {𝒟}_{v a 1}} [ \text{} {\sum }_{i = 0}^{N} {\vert y - {f}_{{h}_{i}} ( x ) \vert}^{2} + 2 {\sum }_{i = 0}^{N} {\sum }_{j \neq l} ( y - {f}_{{h}_{i}} ( x ) ) ( y - {f}_{{h}_{j}} ( x ) ) ] = \frac{1}{{N}^{2}} {𝔼}_{( x , y ) ∼ {𝒟}_{val}} \vert {\sum }_{i = 0}^{N} {\vert y - {f}_{{h}_{i}} ( x ) \vert}^{2} \vert + \frac{2}{{N}^{2}} {\sum }_{i = 0}^{N} {\sum }_{j \neq i} {𝔼}_{( x , y ) ∼ {𝒟}_{val}} \vert ( y - {f}_{{h}_{i}} ( x ) ) ( y - {f}_{h j} ( x ) ) \vert \qquad Eqn . 5$$

In the case of Mean Square Error, an exact equality is achieved rather than an upper bound as described in Eqn. 4. Here, the pairwise diversity loss component 222 for MSE is given as OptDiV_{MSE}(Y, fₕ_{ᵢ}, fₕ_{ⱼ})=4 [symbol] [ϵᵢϵⱼ].

Where, ϵᵢ=y−fₕ_{ₗ}(x). Contrary to DivBO's diversity metric, which aims to increase the divergence between the predictions of different configurations, this metric of pairwise diversity loss component 222 is focused on not merely pushing the predictions apart. Instead, it emphasizes the nuanced approach of minimizing the covariance between errors (assuming [symbol] [ϵ]=0). Thus, indicating a sophisticated strategy for enhancing ensemble performance.

Another prevalent metric in regression-based problems is the Mean Absolute Error MAE), with the ensemble generalization expressed as

$${𝔼}_{( x , y ) ∼ {𝒟}_{val}} [ \vert y - \frac{1}{N} {\sum }_{i = 0}^{N} {f}_{{h}_{i}} ( x ) \vert ] .$$

To decompose MAE into individual model components and pairwise diversity, Eqn. 6 may be utilized.

$${𝔼}_{( x , y ) ∼ {𝒟}_{val}} [ \vert y - \frac{1}{N} {\sum }_{i = 0}^{N} {f}_{{h}_{i}} ( x ) \vert ] = {𝔼}_{( x , y ) ∼ {𝒟}_{val}} [ \sqrt{{\vert y - \frac{1}{N} {\sum }_{i = 0}^{N} {f}_{{h}_{i}} ( x ) \vert}^{2} ]} = \frac{1}{N} {𝔼}_{( x , y ) ∼ {𝒟}_{val}} [ \sqrt{{\sum }_{i = 0}^{N} {\vert y - {f}_{{h}_{i}} ( x ) \vert}^{2} + 2 {\sum }_{i = 0}^{N} {\sum }_{j \neq i} {ϵ}_{i} {ϵ}_{j}} ] \leq \frac{1}{N} {𝔼}_{( x , y ) ∼ {𝒟}_{val}} [ \sqrt{{\sum }_{i = 0}^{N} {\vert y - {f}_{{h}_{i}} ( x ) \vert}^{2}} + \sqrt{2 {\sum }_{i = 0}^{N} {\sum }_{j \neq i} \vert {ϵ}_{i} {ϵ}_{j} \vert} ] \leq \frac{1}{N} {\sum }_{i = 0}^{N} {𝔼}_{( x , y ) ∼ {𝒟}_{val}} [ \vert y - {f}_{{h}_{i}} ( x ) \vert ] + \frac{\sqrt{2}}{N} {𝔼}_{( x , y ) ∼ {𝒟}_{val}} [ \sqrt{\vert {ϵ}_{i} {ϵ}_{j} \vert} ] \qquad Eqn . 6$$

In the context of MAE, the pairwise diversity loss component 222 for MAE is given as

$${OptDiv}_{MAE} ( Y , {f}_{{h}_{i}} , {f}_{{h}_{j}} ) = 2 \sqrt{2} {𝔼}_{( x , y ) ∼ {𝒟}_{val}} [ \sqrt{\vert {ϵ}_{i} {ϵ}_{j} \vert} ] .$$

This, markedly differs from DivBO's approach and is closely tied to the target values Y. Notably, minimizing this form of optimal diversity ensures a reduction in the ensemble generalization error, a guarantee that prior CASH approaches have not provided.

In classification tasks, Cross-Entropy (CE) is a commonly optimized metric. The ensemble generalization error is represented as

$${𝔼}_{( x , y ) ∼ {𝒟}_{val}} [ - log ( \frac{1}{N} {\sum }_{i = 0}^{N} {f}_{{h}_{i}}^{( y )} ( x ) ) ] .$$

### Here,

$${f}_{{h}_{i}}^{( y )}$$

denotes the probability that the learner associated with the configuration hᵢ assigns to the correct class y. To derive the optimal diversity, the gap between the ensemble error and the average individual performance is analyzed using Eqn. 7:

$${𝔼}_{( x , y ) ∼ {𝒟}_{val}} [ - log ( \frac{1}{N} {\sum }_{i = 0}^{N} {f}_{{h}_{i}}^{( y )} ( x ) ) + \frac{1}{N} {\sum }_{j = 0}^{N} log ( {f}_{{h}_{j}}^{( y )} ( x ) ) ] = {𝔼}_{( x , y ) ∼ {𝒟}_{val}} [ \frac{1}{N} {\sum }_{j = 0}^{N} log ( \frac{{f}_{{h}_{j}}^{( y )} ( x )}{{\sum }_{i = 0}^{N} {f}_{{h}_{i}}^{( y )} ( x )} ) - log ( \frac{1}{N} ) ] \qquad Eqn . 7$$

This term can be interpreted as an information-theoretic quantification of ensemble diversity. However, since it is not a pairwise diversity metric, it cannot be directly utilized in the DivBO framework. To circumvent this, an upper-bound may be applied to this metric by observing that

$$log ( \frac{{f}_{{h}_{j}}^{( y )} ( x )}{{\sum }_{i = 0}^{N} {f}_{{h}_{i}}^{( y )} ( x )} ) \leq log ( \frac{{f}_{{h}_{j}}^{( y )} ( x )}{{f}_{{h}_{i}}^{( y )} ( x ) + {f}_{{h}_{j}}^{( y )} ( x )} ) i , j .$$

Applying this to the previous Eqn. 7 yields the pairwise diversity loss component 222 or the optimal pairwise diversity metric given by Eqn. 8:

$${𝔼}_{( x , y ) ∼ {𝒟}_{val}} [ \frac{1}{N} {\sum }_{j = 0}^{N} log ( \frac{{f}_{{h}_{j}}^{( y )} ( x )}{{\sum }_{i = 0}^{N} {f}_{{h}_{d}}^{( y )} ( x )} ) - log ( \frac{1}{N} ) ] \leq {𝔼}_{( x , y ) ∼ {𝒟}_{val}} [ \frac{1}{{N}^{2}} {\sum }_{j = 0}^{N} {\sum }_{i = 0}^{N} log ( \frac{{f}_{{h}_{j}}^{( y )} ( x )}{{f}_{{h}_{j}}^{( y )} ( x ) + {f}_{{h}_{i}}^{( y )} ( x )} ) - log ( \frac{1}{N} ) ] \qquad Eqn . 8$$

Hence, the pairwise diversity loss component 222 may be represented by Eqn. 9 given below:

$${OptDiv}_{CE} ( Y , {f}_{{h}_{l}} , {f}_{{h}_{f}} ) = \frac{1}{N} {𝔼}_{( x , y ) ∼ {𝒟}_{val}} [ log ( \frac{{f}_{{h}_{j}}^{( y )} ( x )}{{f}_{{h}_{j}}^{( y )} ( x ) + {f}_{{h}_{i}}^{( y )} ( x )} ) ] + \frac{1}{N} {𝔼}_{( x , y ) ∼ {𝒟}_{val}} [ log ( \frac{{f}_{{h}_{i}}^{( y )} ( x )}{{f}_{{h}_{i}}^{( y )} ( x ) + {f}_{hj}^{( y )} ( x )} ) ] {OptDiv}_{CE} ( Y , {f}_{{h}_{i}} , {f}_{{h}_{j}} ) = \frac{1}{N} {𝔼}_{( x , y ) ∼ {𝒟}_{val}} [ log ( \frac{{f}_{{h}_{j}}^{( y )} ( x ) {f}_{{h}_{i}}^{( y )} ( x )}{{( {f}_{{h}_{j}}^{( y )} ( x ) + {f}_{{h}_{i}}^{( y )} ( x ) )}^{2}} ) ] \qquad Eqn . 9$$

Similar to MSE and MAE optimal diversity metrics, this term too depends on the labels, unlike DivBO.

The Brier Score (BS) is often regarded as the classification counterpart to the mean square error (MSE) used in regression problems. The ensemble generalization error for the Brier Score is expressed as

$${𝔼}_{( x , y ) ∼ {𝒟}_{val}} [ {\vert y - \frac{1}{N} {\sum }_{i = 0}^{N} {f}_{{h}_{i}} ( x ) \vert}_{2}^{2} ] ,$$

where y represents the one-hot encoded label, and fₕ_{ᵢ}(x) denotes the probability distribution output by the learner for configuration hᵢ. Given its conceptual resemblance to MSE, the approach to deriving optimal diversity for the Brier Score follows a similar path.

Accordingly, the Optimal Diversity or the pairwise diversity loss component 222 for the Brier Score is represented as OptDiv_{BS}(Y, fₕ_{_{c}}, fₕ_{ⱼ})=4 [symbol] [(y−fₕ_{ᵢ}(x))·(y−fₕ_{ⱼ}(x)]. This derivation and all various constituents of the pairwise diversity loss component 222 are fundamentally rooted in first principles, inherently relying on the labels or targets—a critical aspect overlooked by DivBO.

Thus, this formulation of the pairwise diversity loss component 222 ensures that the dual optimization of individual model performance and the diversity surrogate as implemented in the DivBO framework. This in effect, ensures the minimization of ensemble risk across both regression and classification scenarios.

Further, an ensemble of Gradient Boosting Decision Trees is utilized as the Diversity Surrogate ( [symbol] _{div}(fₕ_{ᵢ}, fₕ_{ⱼ})), leveraging their well-established capability to provide well-calibrated uncertainty estimates and its relatively lower training time complexity compared to traditional Gaussian processes. This feature is pivotal for achieving an optimal balance between exploration and exploitation of new hyperparameters. In contrast to DivBO, which focuses on the minimum diversity [symbol] (see, Eq. 2), the derivation of pairwise diversity loss component 222 necessitates aggregating over all configurations in the pool. This is given by Eqn. 10 as follows:

$${μ}_{div} ( h ) = \frac{1}{N} {\sum }_{i = 0}^{N} {\sum }_{θ ∈ 𝒫} {M}_{div}^{i} ( h , θ ) \qquad Eqn . 10$$

Drawing inspiration from the Gaussian Process Lower Confidence Bound (GP-LCB) method, the acquisition function α_{div}(h)=μ_{div}(h)−κσ_{div}(h) can be defined as the acquisition function for the present scenario. Herein, δ_{div}(h) represents the standard deviation of the ensemble's predictions. The final acquisition function combines the performance surrogate and the diversity surrogate. This can be represented by Eqn. 11.

$$α ( h ) = {α}_{Perf} ( h ) + w {α}_{div} ( h ) , w = 2 ( sigmoid ( τ t ) - 0 \text{.5} ) \qquad Eqn . 11$$

Here, w represents the weight assigned to the diversity acquisition function, varying within the range [0,1), t represents the number of BO iterations, and τ dictates the rate at which saturation is approached. This weighting strategy ensures that, in the initial iterations, configurations demonstrating strong individual performance are selected to join the ensemble pool [symbol] .

In a non-limiting example, the following pseudo-code outlines the OptDivBO procedure. In each iteration, following the initial setup, OptDivBO performs the following steps: 1) Fits the performance and diversity surrogates based on the accumulated observations; 2) Constructs a temporary configuration pool by implementing ensemble selection on the observation history; 3) Samples candidate configurations and calculates their ranking values based on the performance, diversity surrogate and the pool; 4) Identifies and suggests a configuration that minimizes the combined ranking value, as defined in Equation 11; and 5) Evaluates the suggested configuration using the validation set, subsequently updating the observation dataset.

Input: Given search budget: B, architecture search space: X,
ensemble size: E, training dataset and validation dataset: Dₜᵣₐᵢₙ, Dᵥₐₗ.
Initialize observations as D = 0;
while B does not exhaust do
if |D| < 5 then
Suggest a random configuration \hat{x} ∈X;
else
Fit performance surrogate M_{perf} and diversity surrogate
M_{div} based on observations D and task specific optimal
diversity metric as seen in section 4;
Build a temporary pool of configurations as P =
{Θ₁, ... , Θ_{E}} = EnsembleSelection (D, Dᵥₐₗ, E);
Compute the ranks of sampled configurations R_{perf}
and R_{div} based on the performance and diversity surrogates
M_{perf}, M_{div} and the temporary pool P;
$Suggest a configuration \hat{x} = arg {min}_{x ∈ X} α ( x ) based on$
Equation 11;
end if
Build and train the learner [symbol] on Dₜᵣₐᵢₙ and evaluate its
performance on Dᵥₐₗ as ŷ;
Update the observations D = D U {(\hat{x}, ŷ)};
Generate a pool [symbol] = {Θ₁, ... , Θ_{E}} =
EnsembleSelection (D, Dᵥₐₗ, E)
end while
return the final ensemble Ensemble {Θ₁, ... , Θ_{E}};

At step 310, the process 300 includes outputting the optimal ensemble model configuration 224. As may be understood, upon completion of the model selection and hyperparameter optimization stage (see, 308), the server system 200 is configured to determine the optimal ensemble model configuration 224 from the one or more ensemble model configurations 220 (or the ensemble pool). This determination is performed by selecting the ensemble model configuration from the ensemble pool with the highest performance as the optimal ensemble model configuration 224. It is noted that pseudo-code returns the final ensemble as the output, i.e., the optimal ensemble model configuration 224.

FIG. 4 illustrates a schematic representation of another environment 400 related to at least some example embodiments of the present disclosure. Although the environment 400 is presented in one arrangement, other embodiments may include the parts of the environment 400 (or other parts) arranged otherwise depending on, operations performed similar to that performed in the environment 100. Thus, it should be noted that the environment 400 is an example implementation of the environment 100, with the environment 400 representing a financial industry in which the users 104 can be at least one of the cardholders and/or merchants. Thus, the data points or samples of the environment 100 may correspond to payment transactions performed between the cardholders and the merchants in the environment 400.

In one embodiment, the environment 400 includes entities, such as the server system 102, a plurality of cardholders 402(1), 402(2), . . . 402(N) (collectively referred to hereinafter as the ‘plurality of cardholders 402’ or simply ‘cardholders 402’), a plurality of merchants 404(1), 404(2), . . . 404(N) (collectively referred to hereinafter as a ‘plurality of merchants 404’ or simply ‘merchants 404’), a plurality of issuer servers 406(1), 406(2), . . . 406(N) (collectively referred to hereinafter as the ‘plurality of issuer servers 406’ or simply ‘issuer servers 406’), a plurality of acquirer servers 408(1), 408(2), . . . 408(N) (collectively referred to hereinafter as the ‘plurality of acquirer servers 408’ or simply ‘acquirer servers 408’), a payment network 410 including a payment server 412, and a database 414 each coupled to, and in communication with (and/or with access to) the network 108. Herein, it may be noted that ‘N’ is a non-zero natural number that may be different for each entity.

As used herein, the term “cardholder” refers to a person who has a payment account or a payment card (e.g., credit card, debit card, etc.,) associated with the payment account, that will be used by a merchant (such as merchant 404(1)) to perform a payment transaction. The payment account may be opened via an issuing bank or an issuer server (e.g., the issuer server 406(1)). The term “merchant” refers to a seller, a retailer, a purchase location, an organization, or any other entity that is in the business of selling goods or providing services, and it can refer to either a single business location or a chain of business locations of the same entity. Further, as used herein, the term “payment network” refers to a network or collection of systems used for the transfer of funds using cash substitutes. Payment networks (including payment network 410) are set up by companies or businesses that connect an issuing bank with an acquiring bank to facilitate digital payments between the cardholders 402 and the merchants 404. In an example, the cardholders 402 may use their corresponding electronic devices (not shown) to access a mobile application or a website associated with the merchants 404, or any third-party payment application to perform a payment transaction.

As may be understood, within the financial domain, ensemble models are generally used for predicting results for down-stream tasks such as fraud detections, authentication intelligence, merchant risk prediction, chargeback risk prediction, pre-authorization amount prediction, and so on. As may be appreciated, to ensure the highest performance while performing these predictive tasks, an optimal ensemble model configuration (such as optimal ensemble model configuration 224) is desired. This optimal ensemble model configuration 224 may include a subset of base models 218 that are geared towards the highest performance while performing the desired predictive analysis.

However, as described earlier, due to the sheer number of possible ML models that can be used to generate an ensemble model configuration, it is quite complex to determine the optimal ensemble model configuration 224. To that end, the server system 102 (i.e., identical to server system 200) has been proposed in the present disclosure which automates the process of determining or selecting the optimal ensemble model configuration 224 for a specific down-stream task such that it has the highest performance during the prediction process.

In an implementation, the server system 102 is coupled with the database 414. In one embodiment, the server system 102 may facilitate payment processors operating the payment network 410 through the payment server 412 in determining the optimal ensemble model configuration 224 as well. In some implementations, the server system 102 can be embodied within a payment server (e.g., the payment server 412) associated with the payment network 410 (owned by the payment processor), however, in other examples, the server system 102 can be a standalone component (acting as a hub) connected to the issuer servers 406 and the acquirer servers 408 as well.

In an embodiment, the database 414 may include a historical transaction dataset 416. The historical transaction dataset 416 may include one or more transaction attributes related to the plurality of transactions performed between the cardholders 402 and the merchants 404. The historical transaction dataset 416 may be maintained and updated with information related to new transactions as they take place in real-time (or near real-time). In other words, the historical transaction dataset 416 is a repository of information associated with all the transactions (or a subset of transactions) performed over a historical time period. In various examples, the historical transaction dataset 416 may, but is not limited to, one or more transaction attributes, such as transaction amount, source of funds such as bank accounts, debit cards or credit cards, transaction channel used for loading funds such as Point Of Sale (POS) terminal or Automated Teller Machine (ATM), transaction velocity features such as count and transaction amount sent in the past ‘x’ number of days to a particular user, external data sources, merchant country, merchant Identifier (ID), cardholder ID, cardholder product, cardholder Permanent Account Number (PAN), Merchant Category Code (MCC), merchant location data or merchant co-ordinates, merchant industry, merchant super industry, ticket price, and other transaction-related data.

In other various examples, the database 414 may also include multifarious data, for example, social media data, Know Your Customer (KYC) data, payment data, trade data, employee data, Anti Money Laundering (AML) data, market abuse data, Foreign Account Tax Compliance Act (FATCA) data, and fraudulent payment transaction data as well.

In an embodiment, the server system 102 is configured to receive the ensemble model generation request from an administrator (not shown) associated with the server system 102. The ensemble model generation request may be for determining a prediction for a fraud detection task. In other words, the administrator may request the server system 102 to generate an optimal ensemble model configuration 224 for performing a fraud detection task for ongoing payment transactions between any of the cardholders 402 and the merchants 404. In response, the server system 102 may be configured to access the historical transaction dataset 416. The server system 102 may split the historical transaction dataset 416 into the training dataset and the validation dataset. For example, considering that the historical transaction dataset 416 represents data collected over 12 months, then the transaction data from January to June can be used as the training dataset and the transaction data from July to December can be used as the validation dataset.

Then, the server system 102 trains the set of base models (such as the set of base models 218) for performing fraud detection using the training dataset extracted from the historical transaction dataset 416. More specifically, features generated using the historical transaction dataset 416 are used to train the base models 218. In other words, the base models 218 are trained to learn or draw inferences from the transaction data present in the training dataset. As described earlier, the base models 218 are selected from the set of available models based on the down-stream task. As may be appreciated, since the transaction data is highly imbalanced in nature (due to the presence of millions of data samples for non-fraud transactions and thousands of data samples for non-fraud transactions), the base models 218 can be specially selected from those available models that show good performance while learning from such imbalanced datasets.

It should be noted that the operations for determining the optimal ensemble model configuration 224 are similar to operations described earlier with reference to FIG. 1 to FIG. 3. Therefore, these operations are not described again in detail for the sake of brevity.

It is noted that the optimal ensemble model configuration 224 determined using the approach described herein will depict the highest performance while predicting whether an ongoing payment transaction will result in fraud or non-fraud in the future (i.e., the fraud detection task).

As may be appreciated, the approach described by the present disclosure can easily be scaled and applied to various down-stream tasks specific to different industries with minor modifications. It is noted that such applications are also covered within the scope of the present disclosure. Another example of an application of the approach of the proposed disclosure being applied in the industry has been described with reference to FIG. 5.

FIG. 5 illustrates a schematic representation of yet another environment 500 related to at least some example embodiments of the present disclosure. Although the environment 500 is presented in one arrangement, other embodiments may include the parts of the environment 500 (or other parts) arranged otherwise depending on, operations performed similar to that performed in the environment 100. Thus, it should be noted that the environment 500 is an example implementation of the environment 100, with the environment 500 representing the healthcare industry in which the users 104 can be at least one of the patients, healthcare providers (such as nurses, doctors, and so on), and/or healthcare institutions. Thus, the data points or samples of the environment 100 may correspond to individual patient records corresponding to the patients recorded at the healthcare institutions in the environment 500.

In one embodiment, the environment 500 includes entities, such as the server system 102, a plurality of patients 502(1), 502(2), . . . 502(N) (collectively referred to hereinafter as a ‘plurality of patients 502’ or simply ‘patients 502’), a plurality of healthcare institutions 504(1), 504(2), . . . 504(N) (collectively referred to hereinafter as a ‘plurality of healthcare institutions 504’ or simply ‘healthcare institutions 504’), a plurality of medical data servers 506(1), 506(2), . . . 506(N) (collectively referred to hereinafter as a ‘plurality of medical data servers 506’ or simply ‘medical data servers 506’), and the database 106 each coupled to, and in communication with (and/or with access to) the network 108. Herein, it may be noted that ‘N’ is a non-zero natural number that may be different for each entity.

As used herein, the term “patient” refers to a person who is receiving or registered to receive medical treatment. The patient (e.g., the patient 502(1)) may receive medical treatment from a healthcare provider or professional, such as a doctor, a nurse, a therapist, or the like. The patients 502 may seek medical assistance due to illness, injury, or other concerns regarding their health. The patients 502 may present with various symptoms, medical conditions, or health-related issues, and they may rely on the healthcare professionals to diagnose, treat, and manage their health-related issues.

The term “healthcare institution” refers to an institution for medical and surgical treatment and/or nursing care for sick or injured people i.e., the patients 502. It is to be noted that healthcare institutions 504 can provide a wide range of medical services, including emergency care, surgery, diagnostic imaging, laboratory testing, specialized treatments, and the like. Examples of healthcare institutions 504 may include hospitals, clinics, urgent care centers, trauma centers, assisted living centers, surgical centers, long-term care centers, rehabilitation centers, mental health facilities, hospices, and the like.

In an example, the healthcare institutions 504 may provide a mobile application or a website for receiving appointments from patients 502. Such websites or applications also play a major role in capturing and storing patient-related data in the medical data servers 506 that may be associated with individual healthcare institutions 504.

The patients 502 may use their corresponding electronic devices to access the mobile application or the website associated with the healthcare institutions 504 to book appointments with the doctors, take medical advice, request certain medical prescriptions, consult a physician, search for nearby hospitals, learn about various diseases or medical conditions, access their test results or diagnosis, or the like.

As may be understood, within the healthcare domain, ensemble models are generally used for predicting results for down-stream tasks such as disease likelihood prediction, cancer prediction, medical issue detection, and the like. As may be appreciated, to ensure the highest performance while performing these predictive tasks, an optimal ensemble model configuration (such as optimal ensemble model configuration 224) is desired. This optimal ensemble model configuration 224 may include the subset of base models 218 that are geared towards the highest performance while performing the desired predictive analysis.

However, as described earlier, due to the sheer number of possible ML models that can be used to generate an ensemble model configuration, it is quite complex to determine the optimal ensemble model configuration 224. To that end, the server system 102 (i.e., identical to server system 200) has been proposed in the present disclosure which automates the process of determining or selecting the optimal ensemble model configuration 224 for a specific down-stream task such that it has the highest performance during the prediction process.

In an implementation, the server system 102 is coupled with the database 508. In one embodiment, the server system 102 may facilitate healthcare institutions 504 operating the healthcare facilities in determining the optimal ensemble model configuration 224 as well. In some implementations, the server system 102 can be embodied within a medical data server (e.g., the medical data server 506(1)) (owned by the healthcare institution 504(1)), however, in other examples, the server system 102 can be a standalone component (acting as a hub) connected to the connected to the medical data servers 506 as well.

In an embodiment, the database 508 may include a patient history dataset 510. The patient history dataset 510 may include patient-related information of the plurality of patients 502. The patient history dataset 510 may be maintained and updated with patent information related to any new patient as they enter the healthcare institution 504(1). In other words, the patient history dataset 510 is a repository of information associated with all the patient-related information associated with the patients 502 who have accessed the services of the healthcare institution 504(1) over a historical time period. In various examples, the patient history dataset 510 may, but is not limited to, patient-related information for all patients 502, such as patient name, date of birth, gender, contact information, other demographic details, insurance information, emergency contact information, and the like. In some examples, the patient history dataset 510 may also include patient-related information for all patients 502, such as family medical history, past medical conditions, past surgeries, past procedures, current and past diagnoses, blood tests, imaging scans, prescription medications, allergies and adverse reactions, reports, consultation history, and referral history, care plans, and discharge summaries, and the like.

In other various examples, the database 508 may also include information provided by the patients 502, information recorded related to the health conditions of the patients 502, consent forms and patient instructions, billing and administrative data, legal and privacy documents, and the like as well.

In an embodiment, the server system 102 is configured to receive the ensemble model generation request from an administrator (not shown) associated with the server system 102. A hospital administrator is an example of an administrator. The ensemble model generation request may be for determining a prediction for a cancer detection task. In other words, the administrator may request the server system 102 to generate an optimal ensemble model configuration 224 for performing a cancer detection task for a patient such as the patient 502(1). In response, the server system 102 may be configured to access the patient history dataset 510. The server system 102 may split the patient history dataset 510 into the training dataset and the validation dataset. For example, considering that the patient history dataset 510 represents data for patients who have been tested for cancer over 12 months, then the patient information from January to June can be used as the training dataset and the patient information from July to December can be used as the validation dataset.

Then, the server system 102 trains the set of base models (such as the set of base models 218) for performing cancer detection using the training dataset extracted from the patient history dataset 510. More specifically, features generated using the patient history dataset 510 are used to train the base models 218. In other words, the base models 218 are trained to learn or draw inferences from the patient information present in the training dataset. As described earlier, the base models 218 are selected from the set of available models based on the down-stream task. As may be appreciated, since the patient information is highly imbalanced in nature (due to the presence of fewer data samples of patients being diagnosed with cancer when compared to the large number of patients 502 who have undergone cancer tests), the base models 218 can be specially selected from those available models which show good performance while learning from such imbalanced datasets.

It should be noted that the operations for determining the optimal ensemble model configuration 224 are similar to operations described earlier with reference to FIGS. 1 to 3. Therefore, these operations are not described again in detail for the sake of brevity.

It is noted that the optimal ensemble model configuration 224 determined using the approach described herein will depict the highest performance while predicting the patient 502(1) has cancer or not (i.e., the cancer detection task). This prediction can help the healthcare provider of the patient 502(1) in determining whether to send the patient for cancer tests (such as biopsies). As may be appreciated since healthcare resources such as testing facilities as often overburdened, such predictions can help to reduce their burden by preventing unnecessary testing while also saving the patient 502(1) financial resources.

It is noted that although FIG. 4 and FIG. 5 describe specific applications of the various embodiments of the present disclosure, the same should not be construed as a limitation to the scope of the present disclosure. In other words, the various embodiments of the present invention can be utilized to perform various other suitable applications as well without departing from the scope of the present disclosure.

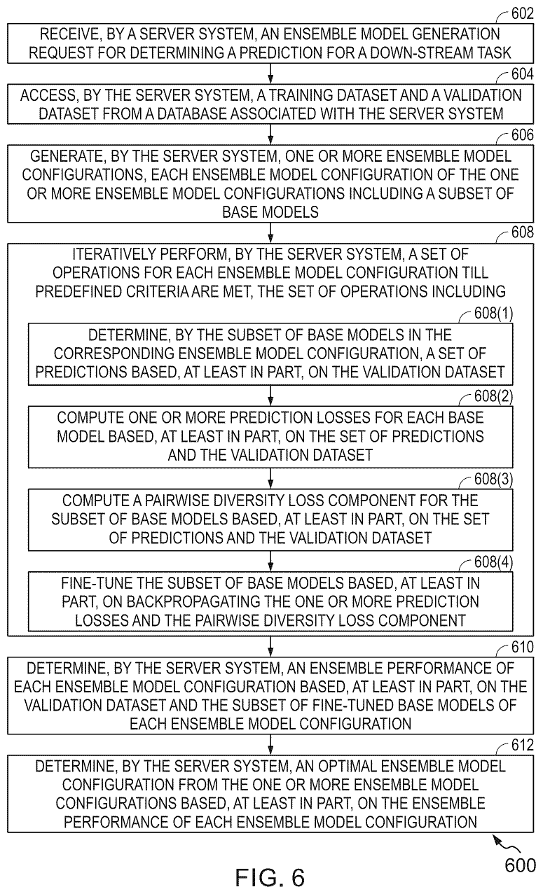

FIG. 6 illustrates a flow diagram depicting a method 600 for determining the optimal ensemble model configuration 224 for performing predictions for a down-stream task, in accordance with an embodiment of the present disclosure. The method 600 depicted in the flow diagram may be executed by, for example, the server system 200. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At operation 602, the method 600 includes receiving, by a server system (e.g., the server system 200), an ensemble model generation request for determining a prediction for a down-stream task. Herein, the down-stream task may refer to any application where the requested ensemble model has to be applied for generating predictions.

At operation 604, the method 600 includes accessing, by the server system 200, a training dataset and a validation dataset from a database 204 associated with the server system 200.

At operation 606, the method 600 includes generating, by the server system 200, one or more ensemble model configurations (e.g., one or more ensemble model configurations 220). Each ensemble model configuration of the one or more ensemble model configurations 220 may include a subset of base models 218. Herein, the subset of base models 218 can be randomly selected from a set of base models (e.g., the set of base models 218). It is noted that the one or more ensemble model configurations 220 represent all possible ensemble configurations for the set of base models 218.

At operation 608, the method 600 includes iteratively performing, by the server system 200, a set of operations for each ensemble model configuration till predefined criteria are met. In some scenarios, the predefined criteria may refer to a fixed number of iterations, a stage during the iterative process where the loss component gets saturated (i.e., no further reduction in loss takes place with successive iterations), and so on. Herein, the set of operations includes performing operations 608(1) to 608(4).

At operation 608(1), the method 600 includes determining, by the subset of base models 218 in the corresponding ensemble model configuration, a set of predictions based, at least in part, on the validation dataset. In an implementation, these predictions are performed for the down-stream task using the data samples present in the validation dataset.

At operation 608(2), the method 600 includes computing, one or more prediction losses for each base model based, at least in part, on the set of predictions and the validation dataset. The one or more prediction losses may be computed using one or more loss functions traditionally associated with each base model of the subset of base models 218.

At operation 608(3), the method 600 includes computing a pairwise diversity loss component (e.g., the pairwise diversity loss component 222) for the subset of base models 218 based, at least in part, on the set of predictions and the validation dataset. Herein, the pairwise diversity loss component 222 is selected based on the model type of each base model. As described earlier, different types of pairwise diversity loss components 222 are suitable for different model types. Thus, the server system 200 automatically selects the best or appropriate pairwise diversity loss component 222 for the ensemble configuration being tested or checked. The goal of the pairwise diversity loss component 222 is to introduce diversity in the learnings of different ensemble model configurations. This aspect has been described earlier in the present disclosure.

At operation 608(4), the method 600 includes fine-tuning, the subset of base models 218 based, at least in part, on backpropagating the one or more prediction losses and the pairwise diversity loss component 222. It is understood that by fine-tuning the models within the selected ensemble model configuration, the impact of diversity on the models can be accounted for.

At operation 610, the method 600 includes determining, by the server system 200, an ensemble performance of each ensemble model configuration based, at least in part, on the validation dataset and the subset of fine-tuned base models 218 of each ensemble model configuration. In other words, once different ensemble model configurations have been fine-tuned or optimized for the highest performance through the various iterations, the overall performance of each ensemble model configuration is determined.

At operation 612, the method 600 includes determining, by the server system 200, an optimal ensemble model configuration (e.g., the optimal ensemble model configuration 224) from the one or more ensemble model configurations 220 based, at least in part, on the ensemble performance of each ensemble model configuration. Herein, the optimal ensemble model configuration 224 is selected based on its ensemble performance being the highest from the various ensemble model configurations determined using operation 610.

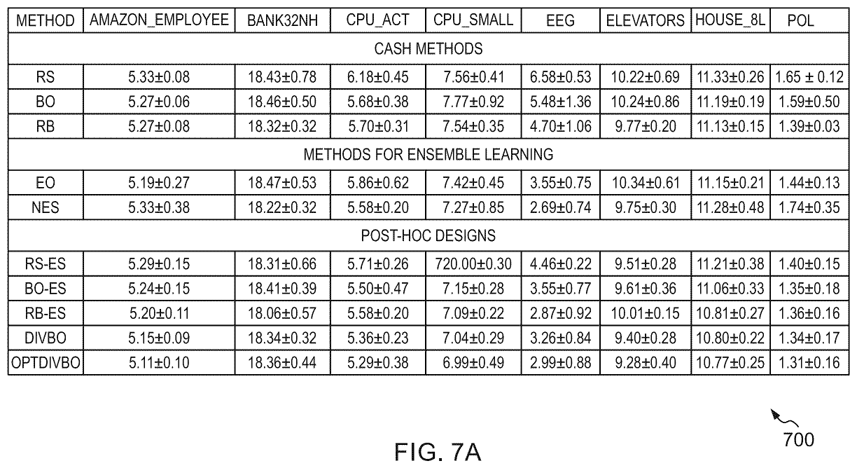

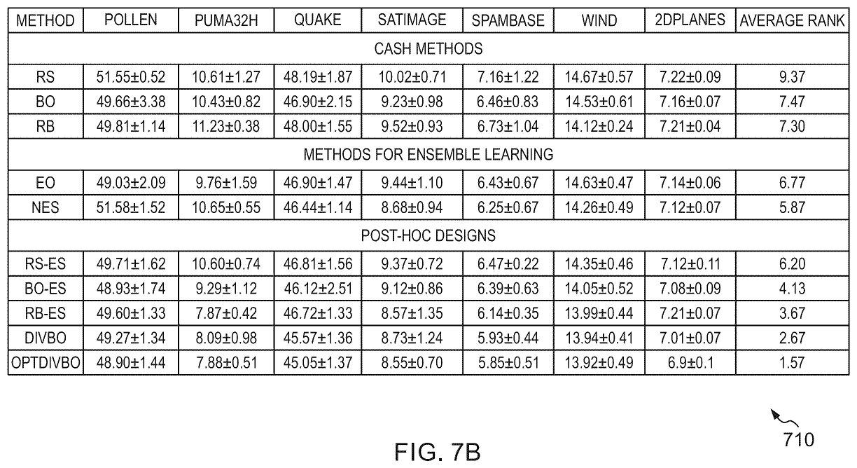

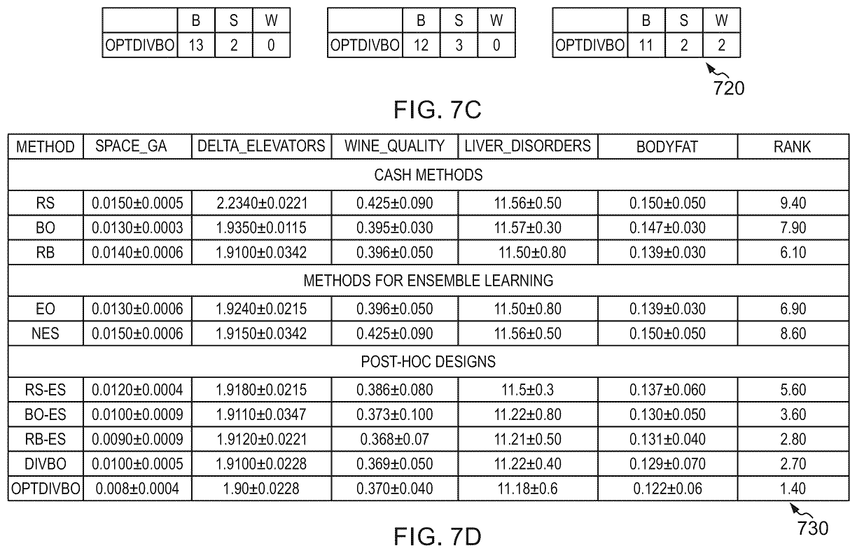

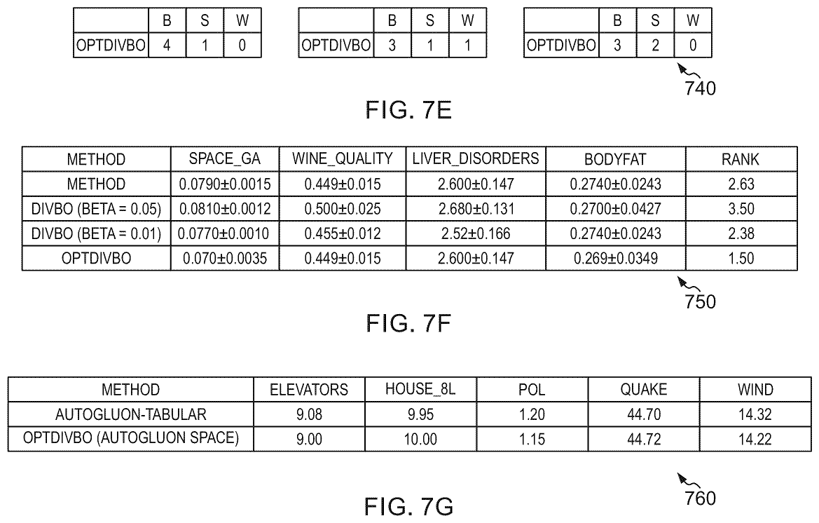

FIG. 7A, FIG. 7B, FIG. 7C, FIG. 7D, FIG. 7E, FIG. 7F, and FIG. 7G, collectively illustrates various tables indicating various experimental results, in accordance with an embodiment of the present disclosure.

As may be appreciated, to check the performance of the proposed approach, (hereinafter referred to as OptDivBO) various experiments have been conducted. In particular, 20 real-world CASH problems have been compared with the proposed approach using publicly available datasets. These experiments depict that the proposed OptDivBO framework surpasses all previous ensemble learning-based CASH approaches, including its predecessor, DivBO, and the choice of diversity metric exerts a statistically significant influence on the overall performance of the ensemble configuration.

During the experiments, the proposed OptDivBO is compared with the following nine baselines: Three CASH methods: 1) Random Search (RS); 2) Bayesian optimization; 3) Rising Bandit (RB); Two AutoML methods proposed for ensemble learning: 4) Ensemble optimization (EO); 5) Neural ensemble search (NES); Four post-hoc designs: 6) Random search with post-hoc ensemble (RS-ES); 7) Bayesian optimization with post-hoc ensemble (BO-ES), which is the default strategy in Auto-sklearn; 8) Rising bandit with post-hoc ensemble (RB-ES), which is the default strategy in VolcanoML; and 9) Diversity Aware BO DivBO.

It is noted that the search space plays a pivotal role in the optimization of CASH problems. To ensure consistency and facilitate a fair comparison of algorithms, these experiments were performed within a unified search space. Specifically, the same search space utilized by DivBO is adopted for experimentation, which encompasses approximately 100 configurations of the ensemble models. The experiments were performed on 15 public classification datasets and 5 regression datasets. These datasets vary in size, with the number of samples ranging from 2,000 samples to 20,000 samples.

During the experiments, the Bayesian optimization surrogate is implemented using OpenBox, an open-source toolkit designed for black-box optimization tasks. For NES, the population size is set to 30; for EO, the ensemble size is set to 12; for RB, α, and trial per action are set to 3 and 5, respectively. In the case of DivBO, the parameters β and τ are set to 0.05 and 0.2. For OptDivBO τ too is fixed at 0.2; for all post-hoc ensemble designs, the ensemble size for ensemble selection is fixed at 25.

Each dataset undergoes a split into three distinct sets: training (60%), validation (20%), and test (20%) dataset. This division ensures a comprehensive evaluation framework. For comparisons with other baseline approaches on CASH problems, the best-observed validation error during the optimization process and the final test error is shown, providing a holistic view of each method's performance. Each baseline evaluates approximately 250 configurations. The evaluation of each method on each dataset is repeated 10 times, and we report the mean±std result. It is noted that the various results shown in Table 1 to Table 6 are experimental in nature and the results may show a deviation of ±5-7% if reproduced. In other words, the various values given in Table 1 to Table 6 are approximate in nature.

Classification Evaluation: The DivBO evaluation metric is inversely proportional to accuracy, defined as, i.e., [symbol] =100−Acc[(Y, fₕ(X)]. The accuracy, or equivalently the 0/1 loss function, is denoted by [symbol] _{0/1}(X, Y)= [symbol] _{(x,y)˜D}_{ₑᵥₐₗ} [symbol] (fₕ(x)≠y). While prior works have explored upper bounding the ensemble generalization error of the 0/1 loss, the proposed approach does not delve into these analyses due to the impracticality of deriving the exact form of optimal diversity for every possible classification metric. Instead, it aims to generalize the understanding of optimal diversity, creating a broadly applicable, diversity-aware black-box BO framework. Therefore, for all metrics beyond those described earlier, the optimal diversity is assumed to be a linear combination of OptDiv_{CE}(Y, fₕ_{ᵢ}, fₕ_{ⱼ})) and OptDiv_{BS}(Y, fₕ_{ᵢ}, fₕ_{ⱼ}), i.e.,

$${OptDiv}_{black - box - metric} ( Y , {f}_{{h}_{i}} , {f}_{{h}_{j}} ) = {β}_{CE} {OptDiv}_{CE} ( Y , {f}_{{h}_{i}} , {f}_{{h}_{j}} ) + {β}_{BS} {OptDiv}_{BS} ( Y , {f}_{{h}_{i}} , {f}_{{h}_{j}} ) \qquad Eqn . 12$$

The hyperparameters β_{CE} and β_{BS} are dependent on the black box metric being optimized. For our 0/1 loss C_{0/1}(X, Y) setting β_{CE}=0.2 and β_{BS}=0.1 yields excellent performance. The results of the classification evaluation are shown in Table 1 (see, table 700 of FIG. 7A). Here, table 700 indicates that the Classification Test error (%) with standard deviations and the average rank across different datasets.

To evaluate the statistical significance of OptDivBO's improvements, the Wilcox is conducted on a signed-rank test for each dataset, comparing two methods. A difference was deemed significant at p≤0.05. The datasets were classified into three categories: 1) instances where OptDivBO's mean error is lower and the difference is statistically significant, labeled as (B); 2) instances with no significant difference, labeled as (S); and 3) instances where OptDivBO's mean error is higher and the difference is statistically significant, labeled as (W). The findings, detailed in Table 2 (see, table 710 of FIG. 7B and table 720 of FIG. 7C), demonstrate that although DivBO establishes a solid baseline, OptDivBO surpasses DivBO on 12 of the 15 datasets and performs at least as well on all. Here, table 710 and table 720 indicates that OptDivBO performs statistically better (B), the same(S), and worse (W).

However, it is noted that OptDivBO underperforms relative to RB-ES on two datasets. This observation suggests a potential avenue for future work, such as integrating a rising bandit-like algorithm selection mechanism into the OptDivBO framework.

The primary distinction between DivBO and OptDivBO lies in their respective diversity metrics, suggesting that despite the theoretical guarantees compromised when addressing the 0/1 loss, the diversity metrics employed by OptDivBO are significantly better suited for ensemble learning.

Regression Evaluation: In regression analysis, the mean square error (MSE) is evaluated on five open-source OpenML regression datasets (see, Table 3 represent by table 730 of FIG. 7D). Herein, table 730 indicates the Regression Test MSE with standard deviations and the average rank. Similar to the classification experiments, all regression tests were conducted ten times to obtain reliable estimates of the mean and standard deviation. For DivBO, the diversity metric Div(hᵢ, hⱼ)= [symbol] _{(x,y)˜D}_{ᵥₐₗ}[(fₕ_{ᵢ}(x)−fₕ_{ⱼ}(x)²] is deployed, maintaining consistency with DivBO's approach in classification tasks. A β value of 0.01 was found to yield the best performance for DivBO.

Table 3 (see, table 730) demonstrates that OptDivBO outperforms both RB-ES and DivBO, achieving the lowest test error in four out of five datasets and securing an average rank of 1.2. The performance gap between DivBO and RB-ES is significantly narrowed, with DivBO achieving an average rank of 2.7 and RB-ES an average rank of 2.8. This observation highlights the profound impact of diversity selection on the performance of Bayesian Optimization (BO) frameworks. Furthermore, Table 4 (see, table 740 of FIG. 7E) indicates that RB-ES is the only method to surpass OptDivBO on one dataset, reinforcing the notion that incorporating intelligent algorithm selection through a multi-armed bandit approach could potentially enhance the OptDivBO/DivBO frameworks further.

Table 5 (see, table 750 of FIG. 7F) depicts an ablation study on the impact of the parameter β on DivBO's performance, on DivBO's performance, using the Mean Absolute Error (MAE) metric for this analysis. BO-ES can be considered as DivBO with β=0. Moderately increasing β to 0.01 appears to enhance the average rank from 2.63 to 2.38. However, further increasing β to 0.05 deteriorates its performance. OptDivBO achieves the lowest average test MAE, underscoring the criticality of optimally balancing diversity with individual model performance. The superiority of OptDivBO over previous methodologies can be attributed to its inherent capability to identify configurations that directly optimize the ensemble generalization error. This strategic focus results in a significant enhancement in performance.

The findings from both these classification and regression experiments establish OptDivBO as a robust black-box BO framework capable of optimizing black-box classification/regression metrics. For standard metrics, it efficiently suggests configurations that directly minimize the ensemble generalization error.

Comparison with AutoGluon: AutoGluon represents a state-of-the-art AutoML system renowned for its sophisticated ensembling and multi-layer stacking of models. Unlike DivBO, which is a Bayesian optimization framework, OptDivBO extends this framework rather than embodying a comprehensive system like AutoGluon. AutoGluon employs a more compact search space compared to auto-sklearn, rendering a direct comparison between OptDivBO (on the auto-sklearn search space) and AutoGluon as potentially inequitable. To facilitate a more equitable comparison, a search space akin to that of AutoGluon was replicated for experimentation purposes.

The outcomes across five datasets are presented in Table 6 (see, table 760 of FIG. 7G). It is evident that the choice of search space significantly influences the results. For instance, AutoGluon's performance on the wind dataset is inferior to that of RS-ES within the auto-sklearn search space. Nonetheless, on the remaining four datasets, AutoGluon surpasses most results obtained using the auto-sklearn space, aligning with observations that AutoGluon frequently outperforms autosklearn. This superiority likely stems from AutoGluon's meticulously curated search space, which effectively excludes less effective algorithms for contemporary datasets while incorporating more robust ones. Notably, implementing DivBO within this search space yielded a decrease in error rates. Specifically, the enhancements were statistically significant on three datasets, not significant on one (quake), and marginally inferior on another.

Therefore, it may be concluded that the proposed framework for selecting an optimal ensemble model configuration (i.e., optimal ensemble model configuration 222) adeptly balances the diversity and individual performance of base learners (i.e., base models 218), thereby optimally minimizing the ensemble generalization error across a broad spectrum of standard regression and classification metrics. Further, these experiments demonstrate the effectiveness of the proposed framework as a versatile Black Box optimization framework, proficient in optimizing a wide array of classification and regression metrics beyond those explicitly addressed herein.

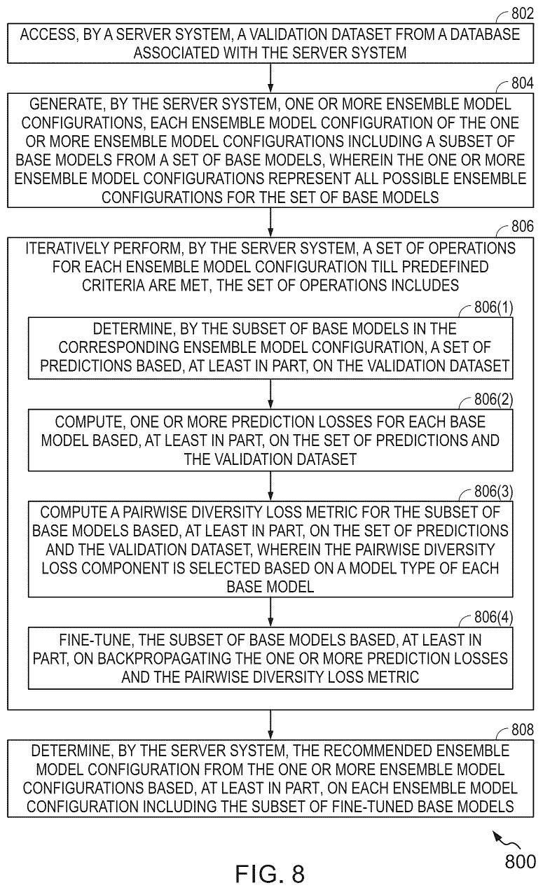

FIG. 8 illustrates a flow diagram depicting a method 800 for determining the recommended ensemble model configuration, i.e., the optimal ensemble model configuration 224 for performing predictions for a down-stream task, in accordance with an embodiment of the present disclosure. The method 800 depicted in the flow diagram may be executed by, for example, the server system 200. The sequence of operations of the method 800 may not be necessarily executed in the same order as they are presented. Further, one or more operations may be grouped and performed in the form of a single step, or one operation may have several sub-steps that may be performed in parallel or in a sequential manner. Operations of the method 800, and combinations of operations in the method 800 may be implemented by, for example, hardware, firmware, a processor, circuitry, and/or a different device associated with the execution of software that includes one or more computer program instructions. The plurality of operations is depicted in the process flow of the method 800. The process flow starts at operation 802.

At operation 802, the method 800 includes accessing, by a server system such as server system 200, a validation dataset from a database associated with the server system.

At operation 804, the method 800 includes generating, by the server system 200, one or more ensemble model configurations. Each ensemble model configuration of the one or more ensemble model configurations includes a subset of base models from a set of base models. Herein, the one or more ensemble model configurations represent all possible ensemble configurations for the set of base models.

At operation 806, the method 800 includes iteratively performing, by the server system 200, a set of operations for each ensemble model configuration till predefined criteria are met. The set of operations includes performing operations 804(1) to 804(4).

At operation 806(1), the method 800 includes determining, by the subset of base models in the corresponding ensemble model configuration, a set of predictions based, at least in part, on the validation dataset.

At operation 806(2), the method 800 includes computing, one or more prediction losses for each base model based, at least in part, on the set of predictions and the validation dataset.

At operation 806(3), the method 800 includes computing a pairwise diversity loss metric for the subset of base models based, at least in part, on the set of predictions and the validation dataset. Herein, the pairwise diversity loss component is selected based on a model type of each base model.

At operation 806(4), the method 800 includes fine-tuning, the subset of base models based, at least in part, on backpropagating the one or more prediction losses and the pairwise diversity loss metric.

At operation 808, the method 800 includes determining, by the server system 200, the recommended ensemble model configuration from the one or more ensemble model configurations based, at least in part, on each ensemble model configuration including the subset of fine-tuned base models.

The disclosed method 600, 800 with reference to FIG. 6 and FIG. 8, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers.

Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor (e.g., processor 206) or the computer to perform one or more operations. A computer-readable medium storing, embodying, or encoded with a computer program, or similar language, may be embodied as a tangible data storage device storing one or more software programs that are configured to cause the processor (e.g., processor 206) or computer to perform one or more operations. Such operations may be, for example, any of the steps or operations described herein.

In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g., magneto-optical disks), Compact Disc Read-Only Memory (CD-ROM), Compact Disc Recordable CD-R, Compact Disc Rewritable CD-R/W), Digital Versatile Disc (DVD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which, are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for determining a recommended ensemble model configuration, comprising:
accessing, by a server system, a validation dataset from a database associated with the server system;
generating, by the server system, one or more ensemble model configurations, each ensemble model configuration of the one or more ensemble model configurations comprising a subset of base models from a set of base models, wherein the one or more ensemble model configurations represent all possible ensemble configurations for the set of base models;
iteratively performing, by the server system, a set of operations for each ensemble model configuration till predefined criteria are met, the set of operations comprising:
determining, by the subset of base models in the corresponding ensemble model configuration, a set of predictions based, at least in part, on the validation dataset;
computing, one or more prediction losses for each base model based, at least in part, on the set of predictions and the validation dataset;
computing a pairwise diversity loss metric for the subset of base models based, at least in part, on the set of predictions and the validation dataset, wherein the pairwise diversity loss component is selected based on a model type of each base model; and
fine-tuning, the subset of base models based, at least in part, on backpropagating the one or more prediction losses and the pairwise diversity loss metric; and
determining, by the server system, the recommended ensemble model configuration from the one or more ensemble model configurations based, at least in part, on each ensemble model configuration comprising the subset of fine-tuned base models.

2. The computer-implemented method as claimed in claim 1, wherein computing the pairwise diversity loss metric comprises:
selecting a pairwise diversity loss component based on a model type of each base model in the subset of base models in the corresponding ensemble model configuration; and
generating the pairwise diversity loss metric for the subset of base models based, at least in part, on the pairwise diversity loss component, the set of predictions, and the validation dataset.

3. The computer-implemented method as claimed in claim 1, wherein fine-tuning the subset of base models comprises:
computing an ensemble generalization error for the subset of base models based, at least in part, on the one or more prediction losses and the pairwise diversity loss metric; and
fine-tuning, the subset of base models based, at least in part, on backpropagating the ensemble generalization error.

4. The computer-implemented method as claimed in claim 1, wherein determining the recommended ensemble model configuration comprises:
computing, by the server system, an ensemble performance of each ensemble model configuration based, at least in part, on the validation dataset and the subset of fine-tuned base models of each ensemble model configuration; and
selecting, by the server system, the recommended ensemble model configuration from the one or more ensemble model configurations based, at least in part, on the ensemble performance of each ensemble model configuration, wherein the recommended ensemble model configuration has the highest ensemble performance.

5. The computer-implemented method as claimed in claim 1, wherein the subset of base models in each ensemble model configuration of the one or more ensemble model configurations is randomly selected from the set of base models.

6. The computer-implemented method as claimed in claim 1, further comprising:
receiving, by the server system, an ensemble model generation request for generating the recommended ensemble model configuration for performing a down-stream task;
accessing, by the server system, a training dataset from the database associated with the server system;
determining, by the server system, a data type of the training dataset and the validation dataset; and
selecting, by the server system, the set of base models from a set of available models based, at least in part, on the down-stream task and the data type.

7. The computer-implemented method as claimed in claim 6, further comprising:
generating, by the server system, a set of features based, at least in part, on the training dataset;
determining, by the server system, feature importance of each feature in the set of features;
extracting, by the server system, a set of important features from the set of features based, at least in part, on the feature importance of each feature and an importance threshold; and
training, by the server system, the set of base models based, at least in part, on the training dataset and the set of important features.

8. The computer-implemented method as claimed in claim 1, wherein the one or more prediction losses are computed using one or more loss functions associated with each base model of the subset of base models.

9. The computer-implemented method as claimed in claim 1, further comprising:
receiving, by the server system, a request for generating a prediction for a down-stream task; and
generating, by the recommended ensemble model configuration, the prediction for the down-stream task.

10. A server system, comprising:
a communication interface;
a memory comprising executable instructions; and
a processor communicably coupled to the communication interface and the memory, the processor configured to cause the server system to at least:
access a validation dataset from a database associated with the server system;
generate one or more ensemble model configurations, each ensemble model configuration of the one or more ensemble model configurations comprising a subset of base models from a set of base models, wherein the one or more ensemble model configurations represent all possible ensemble configurations for the set of base models;
iteratively perform, by the server system, a set of operations for each ensemble model configuration till predefined criteria are met, the set of operations comprising:
determine, by the subset of base models in the corresponding ensemble model configuration, a set of predictions based, at least in part, on the validation dataset;
compute, one or more prediction losses for each base model based, at least in part, on the set of predictions and the validation dataset;
compute a pairwise diversity loss metric for the subset of base models based, at least in part, on the set of predictions and the validation dataset, wherein the pairwise diversity loss component is selected based on a model type of each base model; and
fine-tune, the subset of base models based, at least in part, on backpropagating the one or more prediction losses and the pairwise diversity loss metric; and
determine a recommended ensemble model configuration from the one or more ensemble model configurations based, at least in part, on each ensemble model configuration comprising the subset of fine-tuned base models.

11. The server system as claimed in claim 10, wherein to compute the pairwise diversity loss metric, the server system is further caused at least to:
select a pairwise diversity loss component based on a model type of each base model in the subset of base models in the corresponding ensemble model configuration; and
generate the pairwise diversity loss metric for the subset of base models based, at least in part, on the pairwise diversity loss component, the set of predictions, and the validation dataset.

12. The server system as claimed in claim 10, wherein to fine-tune the subset of base models, the server system is further caused at least to:
compute an ensemble generalization error for the subset of base models based, at least in part, on the one or more prediction losses and the pairwise diversity loss metric; and
fine-tune, the subset of base models based, at least in part, on backpropagating the ensemble generalization error.

13. The server system as claimed in claim 10, wherein to determine the recommended ensemble model configuration, the server system is further caused at least to:
compute an ensemble performance of each ensemble model configuration based, at least in part, on the validation dataset and the subset of fine-tuned base models of each ensemble model configuration; and
select the recommended ensemble model configuration from the one or more ensemble model configurations based, at least in part, on the ensemble performance of each ensemble model configuration, wherein the recommended ensemble model configuration has the highest ensemble performance.

14. The server system as claimed in claim 10, wherein the subset of base models in each ensemble model configuration of the one or more ensemble model configurations is randomly selected from the set of base models.

15. The server system as claimed in claim 10, wherein the server system is further caused at least to:
receive an ensemble model generation request for generating the recommended ensemble model configuration for performing a down-stream task;
access a training dataset from the database associated with the server system;
determine a data type of the training dataset and the validation dataset; and
select the set of base models from a set of available models based, at least in part, on the down-stream task and the data type.

16. The server system as claimed in claim 15, wherein the server system is further caused at least to:
generate a set of features based, at least in part, on the training dataset;
determine feature importance of each feature in the set of features;
extract a set of important features from the set of features based, at least in part, on the feature importance of each feature and an importance threshold; and
train the set of base models based, at least in part, on the training dataset and the set of important features.

17. The server system as claimed in claim 10, wherein the one or more prediction losses are computed using one or more loss functions associated with each base model of the subset of base models.

18. The server system as claimed in claim 10, wherein the server system is further caused at least to:
receive a request for generating a prediction for a down-stream task; and
generate, by the recommended ensemble model configuration, the prediction for the down-stream task.

19. A non-transitory computer-readable storage medium comprising computer-executable instructions that, when executed by at least a processor of a server system, cause the server system to perform a method comprising:
accessing a validation dataset from a database associated with the server system;
generating one or more ensemble model configurations, each ensemble model configuration of the one or more ensemble model configurations comprising a subset of base models from a set of base models, wherein the one or more ensemble model configurations represent all possible ensemble configurations for the set of base models;
iteratively performing a set of operations for each ensemble model configuration till predefined criteria are met, the set of operations comprising:
determining, by the subset of base models in the corresponding ensemble model configuration, a set of predictions based, at least in part, on the validation dataset;
computing, one or more prediction losses for each base model based, at least in part, on the set of predictions and the validation dataset;
computing a pairwise diversity loss metric for the subset of base models based, at least in part, on the set of predictions and the validation dataset, wherein the pairwise diversity loss component is selected based on a model type of each base model; and
fine-tuning, the subset of base models based, at least in part, on backpropagating the one or more prediction losses and the pairwise diversity loss metric; and
determining the recommended ensemble model configuration from the one or more ensemble model configurations based, at least in part, on each ensemble model configuration comprising the subset of fine-tuned base models.

20. The non-transitory computer-readable storage medium as claimed in claim 19, wherein the computing the pairwise diversity loss metric comprises:
selecting a pairwise diversity loss component based on a model type of each base model in the subset of base models in the corresponding ensemble model configuration; and
generating the pairwise diversity loss metric for the subset of base models based, at least in part, on the pairwise diversity loss component, the set of predictions, and the validation dataset.
